(19) United States
(12) Patent Application Publication
(10) Pub. No.: US 2007/0105536 A1
(43) Pub. Date: May 10, 2007

(54) Methods and apparatus for providing SMS notification, advertisement and e-commerce systems for university communities

(76) Inventor: George Tingo JR., Gainesville, FL (US)

Correspondence Address: LAW OFFICE OF JAMES TROSINO, 92 NATOMA STREET, SUITE 211, SAN FRANCISCO, CA, 94105, US

(21) Appl. No.: 11/268,179

(22) Filed: Nov. 7, 2005

(51) Int. Cl. H04Q 7/38

(52) U.S. Cl. 455/414.1; 455/455; 455/412.1; 455/466

(57) ABSTRACT

Apparatus and methods are provided for providing SMS notification, SMS advertisement, web advertisement and e-commerce systems for university communities. A messaging platform includes a web server and a database. The web server provides student, university, merchant and web advertiser interfaces for communications with students, university users, merchants and web advertisers, respectively, and back-end interfaces for communications with SMS aggregators and wireless carriers used to communicate SMS messages to the students' Mobile Devices and web advertisements to student clients. The database stores information regarding the students' demographic information and interest categories. The messaging platform may be used by university users and merchants to send SMS notification and advertisement messages, respectively, to the mobile devices of students based on interest category information extracted from the database. The messaging platform also may be used by web advertisers to display web advertisements in web pages displayed on student clients based on interest category information extracted from the database

### BACKGROUND

Portable wireless communication devices, such as pagers, personal digital assistants (“PDAs”), cell phones, wireless handheld devices, handheld computers and other portable wireless communication devices, referred to herein collectively as “Mobile Devices,” have become increasingly popular within the last decade. Mobile Devices variously permit users to send and receive email, text messages, instant messages and documents, and to make and receive wireless telephone calls. As this technology evolves, Mobile Devices are being developed that perform all of these functions. For example, cell phones are now available that may be used not only to make and receive telephone calls, but also to send and receive email and text messages, browse the Internet, and perform other PDA tasks. Additionally, PDAs also now are available that include email, text messaging, Web browsing and wireless telephone functionality.

Most Mobile Devices now typically include some form of advanced non-speech service, such as short message service (“SMS”), multimedia message service (“MMS”) or other message service. SMS is a subscriber service that operates similar to pager service. With SMS, a Mobile Device user may receive and transmit “short” text messages without establishing a voice circuit connection. These short text messages typically are limited to about 160 alphanumeric characters, and are transmitted on a control channel typically separate from the band used for voice transmission. MMS is a relatively new subscriber service that is similar to SMS, but permits communication of longer text messages, plus images, audio and video.

One relatively recent application of SMS services is for wireless advertising, sometimes referred to as “mobile marketing.” Indeed, as Mobile Devices have become increasingly prevalent, marketers have discovered that SMS services provide the opportunity to reach an enormous audience via SMS messaging. In particular, mobile marketers have used SMS services to deliver SMS ads, service reminders, “mobile coupons” and special announcements In addition, using two-way SMS messaging, mobile marketers have used SMS services to conduct contests, surveys, trivia games, voting, and e-commerce transactions with recipients.

To specifically target ads to desired audiences, and to avoid negative connotations associated with sending unsolicited SMS messages, many mobile marketers send SMS ads only to Mobile Device users who agree to receive such messages from specific providers. Indeed, mobile marketers have found that permission-based, or “opt-in,” mobile marketing campaigns are much more effective than using mass solicitations. Thus, many mobile marketers have discovered that obtaining access to a large population of Mobile Device users, and achieving a high rate of opt-in participation is vital to the success of SMS marketing campaigns.

One highly desirable target audience for mobile marketing campaigns are college students. Indeed, the vast majority of college students now use some form of Mobile Device. Also, many college students frequently use SMS services, and are comfortable with the technology. Further, because college students are often early adopters of new technology and trends, college students may be more receptive to receiving marketing information via SMS ads. Perhaps most importantly, college students fall within the desirable 18-49 age demographic coveted by advertisers.

One problem that has confronted mobile marketers, however, is obtaining access to this highly desirable market segment. Typically, advertisers have had to solicit opt-in acceptance for mobile marketing campaigns by using other traditional forms of marketing. For example, marketers have obtained opt-in agreements from Mobile Device users by placing advertisements or sponsoring contests using print media, billing inserts, billboards, and television and radio commercials. Such traditional techniques are expensive, however, and often fail to achieve the rates of opt-in acceptance that are required to make mobile marketing campaigns economically viable.

One potential source of access to college students is via SMS systems that have been implemented by universities. For example, the University Of South Florida (“USF”) has implemented a limited SMS system includes a mobile marketing program that provides local retailer advertisements to students on an opt-in basis. The USF system, however, does not appear to have been officially adopted by USF for university-related communications with students, and thus the student acceptance rate of the system may not be as high as might otherwise be possible. Indeed, because mobile carriers typically charge the sender a fee for each sent SMS message, universities may be reluctant or unable to allocate funds to implement and utilize SMS systems. Also, the USF system does not appear to provide e-commerce capabilities.

One other previously known SMS system that has been implemented at a university, and that incorporates mobile marketing features, is the DAWGTEL Messaging Service (“DAWGTEL”) implemented at Southern Illinois University (“SIU”). DAWGTEL includes an alerting feature that allows SIU faculty and staff to send SMS Messages to students and faculty regarding academic matters (e.g., class cancellations, room changes, career center information, etc.), and a permission-based marketing feature that businesses may use to send SMS ads to users. Although DAWGTEL includes many desirable features, it's use appears to be limited to a single university. As a result, DAWGTEL may not provide advertisers with access to as wide an audience as desired for cost-effective and successful mobile marketing campaigns. Further, the USF system also does not appear to provide e-commerce capabilities.

In view of the foregoing, it would be desirable to provide methods and apparatus for providing SMS notification, advertisement and e-commerce systems for university communities.

It also would be desirable to provide methods and apparatus that allow universities to implement SMS notification systems at a reduced cost.

It further would be desirable to provide methods and apparatus for increasing the participation of college students in permission-based mobile marketing campaigns that use SMS advertisement messages.

### SUMMARY

This invention provides apparatus and methods for implementing SMS communications systems for university communities. SMS systems in accordance with this invention may be used by a university to allow the university's users (e.g., administrators, faculty, staff and student groups) to create and send SMS notification messages to the mobile devices of the university's students who agree to receive such messages. In particular, university users may target SMS notification messages to students based on the students' specified notification interest categories. Each university student who elects to receive such notification messages also may agree to receive a minimum number of SMS advertisement messages during a predetermined time period from merchants whose products or services match advertisement interest categories specified by the student.

In particular, merchants may use systems and methods of this invention to target SMS advertisement messages to students at one or more universities based on the students' specified advertisement interest categories. In addition, web advertisers may use systems and methods of this invention to target web advertisements to students at one or more universities based on the students' specified advertisement interest categories. Further, university users and merchants may use systems and methods in accordance with this invention to conduct e-commerce transactions with students via SMS messages.

A system operator may charge university users a first fee for each SMS notification message sent via the messaging system, may charge merchants a second fee for each SMS advertisement message sent via the messaging system, and may charge web advertisers a third fee for each web advertisement delivered via the messaging system. The first fee may be zero (e.g., the system operator may allow university users to send SMS notification message for free), and the second and third fees may be non-zero. The system operator may charge university users and advertisers a fourth fee for each e-commerce SMS message. For example, the fourth fee may be a flat fee for each transaction, or may be a percentage of the monetary amount of each transaction.

### BRIEF DESCRIPTION OF THE DRAWINGS

Features of the present invention can be more clearly understood from the following detailed description considered in conjunction with the following drawings, in which the same reference numerals denote the same elements throughout, and in which:

FIG. 1 is a block diagram of an exemplary SMS system in accordance with this invention;

FIG. 2 is an alternative block diagram of an exemplary SMS system in accordance with this invention;

FIG. 3 is a block diagram illustrating exemplary components of messaging platforms in accordance with this invention;

FIG. 4 is an exemplary first database portion that includes identifying student data;

FIG. 5 is an exemplary second database portion that includes non-identifying student data;

FIGS. 6A-6F are diagrams illustrating exemplary data categories in accordance with this invention;

FIG. 7 is a block diagram illustrating exemplary components of wireless interfaces in accordance with this invention;

FIG. 8 is an exemplary sign-on web page provided by a student interface in accordance with this invention;

FIG. 9 is an exemplary student profile web page provided by a student interface in accordance with this invention;

FIG. 10 is an exemplary control settings web page provided by a student interface in accordance with this invention;

FIG. 11 is an exemplary notification interest categories web page provided by a student interface in accordance with this invention;

FIG. 12 is an exemplary advertisement interest categories web page provided by a student interface in accordance with this invention;

FIG. 13 is an exemplary sign-on web page provided by a university user interface in accordance with this invention;

FIG. 14 is an exemplary university message manager provided by a university interface in accordance with this invention;

FIG. 15 is an exemplary profile selection manager provided by a university interface in accordance with this invention;

FIG. 16 is an exemplary timeslot selection manager provided by a university interface in accordance with this invention;

FIGS. 17A-17D are diagrams of exemplary SMS notification messages and e-commerce SMS messages displayed on student mobile devices in accordance with this invention;

FIG. 18 is an exemplary sign-on web page provided by a merchant interface in accordance with this invention;

FIG. 19 is an exemplary merchant profile web page provided by a merchant interface in accordance with this invention;

FIG. 20 is an exemplary access level web page provided by a merchant interface in accordance with this invention;

FIG. 21 is an exemplary message plans web page provided by a merchant interface in accordance with this invention;

FIG. 22 is an exemplary merchant message manager provided by a merchant interface in accordance with this invention;

FIG. 23 is exemplary profile selection manager provided by a merchant interface in accordance with this invention;

FIG. 24 is an exemplary timeslot selection manager provided by a merchant interface in accordance with this invention; and

FIGS. 25A-25D are diagrams of exemplary SMS advertisement messages and e-commerce SMS messages displayed on student mobile devices in accordance with this invention.

### DETAILED DESCRIPTION

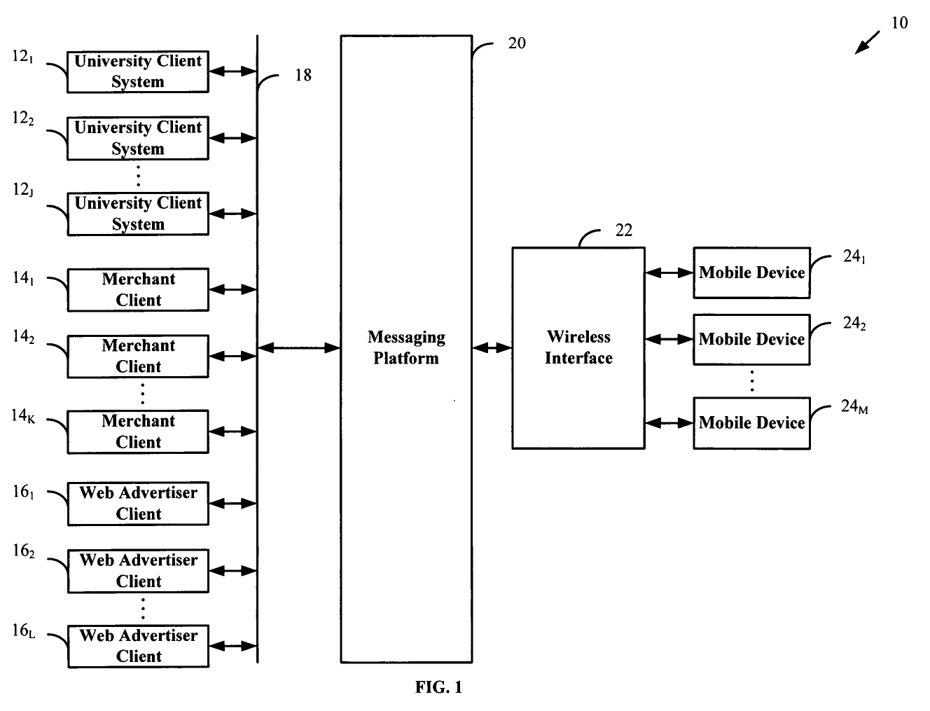

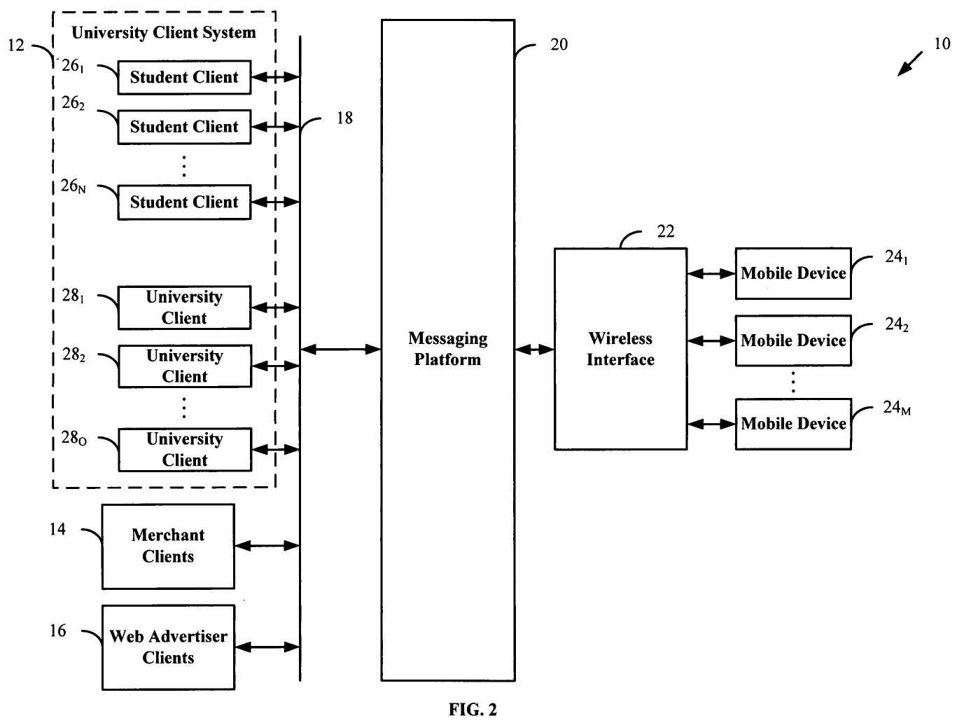

Referring now to FIG. 1, an exemplary SMS system in accordance with this invention is described. In particular, SMS System 10 includes one or more university client systems 12₁, 12₂, . . . , 12_{J}, merchant clients 14₁, 14₂, . . . , 14_{K}, and web advertiser clients 16₁, 16₂, . . . , 16_{L}, coupled via network 18 to messaging platform 20, which is further coupled via wireless interface 22 to mobile devices 24₁, 24₂, . . . , 24_{M}. As shown in FIG. 2, each university client system 12 may include student clients 26₁, 26₂, . . . , 26_{N} and university clients 28₁, 28₂, . . . , 28_{O} (for simplicity, a single university client system 12 is illustrated).

Each of student clients 26, university clients 28, merchant clients 14 and web advertiser clients 16 may be a personal computer, laptop computer, handheld computer, computer server, personal digital assistant, web-enabled cell phone or other similar computer device or combination of such devices. In addition, each student client 26, university client 28, merchant client 14 and web advertiser client 16 may include browser software, such as Internet Explorer, Firefox or other similar web browser software, for displaying web pages. One or more of student clients 26, university clients 28, merchant clients 14 and web advertiser clients 16 may be combined on a single device. For example, a single personal computer may operate as both a student client 26 and a university client 28, and a single web-enabled cell phone may operate as both a merchant-client 14 and a web advertiser client 16.

In accordance with this invention, messaging platform 20 enables university users at a university (e.g., administrators, faculty, staff, student groups, etc.) to use university clients 28 to create and send SMS notification messages to their students' mobile devices 24. Each student may use a student client 26 to set SMS message preferences and specify notification and advertisement interest categories about which the student would like to receive SMS messages from university users and merchants (e.g., local, regional and national stores, restaurants, barbershops, etc.). By using the student's specified advertisement preferences, messaging platform 20 enables merchants to use merchant clients 14 to send targeted SMS advertisement messages to students' mobile devices 24 at one or more universities, and enables web advertisers to use web advertiser clients 16 to display targeted web advertisements on student clients 26 at one or more universities. Further, messaging platform 20 enables university users and merchants to conduct e-commerce transactions with students via SMS messages.

Unless otherwise stated, the term “SMS message” is used herein to refer to any message communicated via an SMS, MMS, FlashSMS, V CAST, or other similar message service. Thus, SMS notification and advertisement messages may include text data, image data, audio data, video data, and any other data that may be communicated via an SMS message service. In addition, unless otherwise stated, the term “web advertisement” is used herein to refer to any advertisement message that may be displayed on a web page. Thus, web advertisements may include banner ads, pop-up ads, sponsored links, or any other similar advertisement that may be displayed in a web page.

Referring again to FIG. 1, network 18 may be a local area network, wide area network, the Internet, or other similar network or combination of such networks. Network 18 may be a single network, or may be multiple networks. For example, network 18 may include a first network (not shown) that is used to communicate between university message system 12, and messaging platform 20, a second network (not shown) that is used to communicate between university message system 122 and messaging platform 20, a third network (not shown) that is used to communicate between merchant client 14, and messaging platform 20, a fourth network (not shown) that is used to communicate between web advertiser client 16, and messaging platform 20, and so on. For simplicity, the remaining discussion assumes that network 18 is a single network, such as the Internet. As described in more detail below, wireless interface 22 includes hardware and/or software that enables messaging platform 20 to communicate with a wide variety of wireless carriers for sending and receiving SMS messages to and from mobile devices 24.

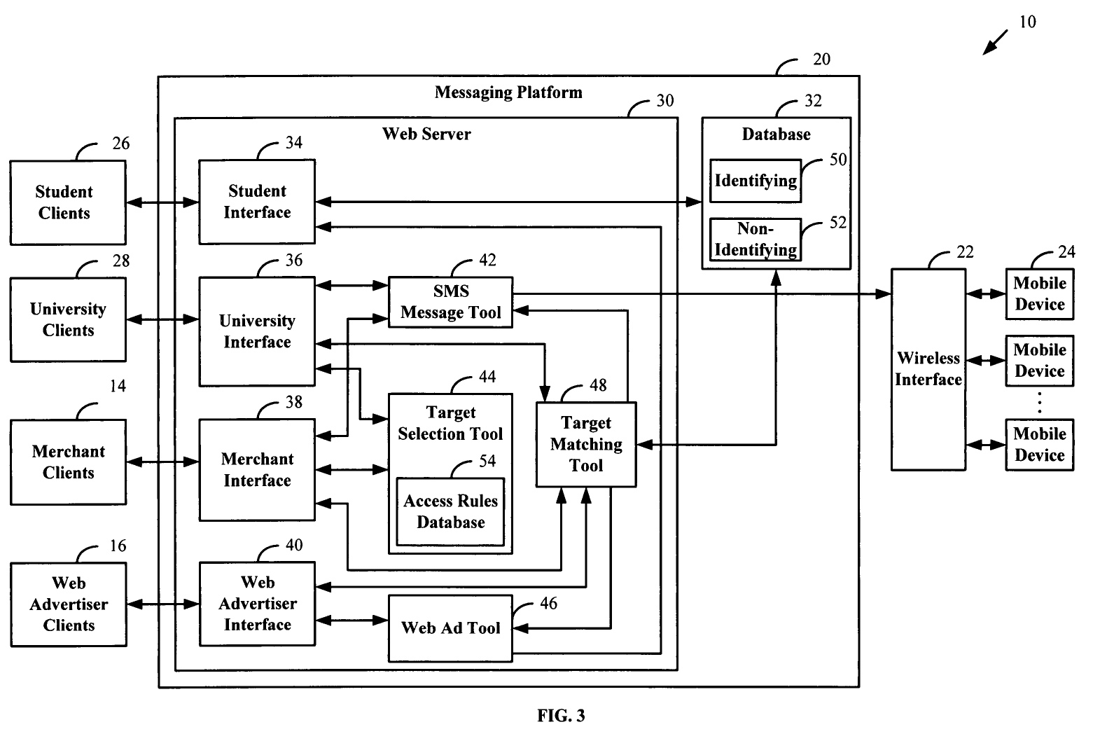

Referring now to FIG. 3, an exemplary messaging platform 20 is described. Messaging platform 20 may be a mainframe computer, personal computer, laptop computer, handheld computer, computer server, or other similar computer device or combination of such devices. Messaging platform 20 includes web server 30 and database 32, which may be included together on a single computer device, or may be distributed amongst multiple computer devices. Web server 30 may include student interface 34, university interface 36, merchant interface 38, web advertiser interface 40, SMS message tool 42, target selection tool 44, web advertisement tool 46 and target matching tool 48.

Student interface 34 may include hardware and/or software for hosting one or more SMS system web pages that students may browse using student clients 26 to provide information for storage in database 32. The stored information may include the student's mobile device 24 address, demographic information, SMS message preferences and notification and advertisement interest categories. In addition, student interface 34 also may include hardware and/or software for inserting web advertisements provided by web advertisers using web advertiser interface 40 into the SMS system web pages displayed on student clients 26.

University interface 36 may include hardware and/or software for hosting one or more web pages that university users may browse using university clients 28 to create SMS notification messages, specify targeted recipients for the messages based on student demographics and/or notification interest categories, select message delivery timeslots, specify the number of notification messages to send, and send the SMS messages to the mobile devices 24 of the targeted students. University interface 36 also may include hardware and/or software for conducting e-commerce transactions with students via SMS messages.

Merchant interface 38 may include hardware and/or software for hosting one or more web pages that merchants may browse using merchant clients 14 to create SMS advertisement messages, specify targeted recipients for the SMS messages based on student demographics and/or advertisement interest categories, select message delivery timeslots, specify the number of advertisement messages to send, and send the SMS messages to the mobile devices 24 of the targeted students. Merchant interface 38 also may include hardware and/or software for conducting e-commerce transactions with students via SMS messages.

Web advertiser interface 40 may include hardware and/or software for hosting one or more web pages that web advertisers may browse using web advertiser clients 16 to create web advertisements, specify targeted recipients for the web advertisements based on student demographics and/or advertisement interest categories, select web advertisement priorities, specify the number of web advertisements to deliver, and display the web advertisements in SMS system web pages displayed by the student clients 26 of the targeted recipients.

For enhanced security, one or more of student interface 34, university interface 36, merchant interface 38 and web advertiser interface 40 may use encryption techniques to protect the data communicated with students, university users, merchants and web advertisers, respectively.

University interface 36 and merchant interface 38 may be coupled to SMS message tool 42, which may include hardware and/or software for creating, addressing and sending SMS messages. SMS message tool 42 also may include hardware and/or software for conducting e-commerce transactions via SMS messages. Web advertiser interface 40 may be coupled to web advertisement tool 42, which may include hardware and/or software for creating and addressing web advertisement messages.

University interface 36, merchant interface 38 and web advertiser interface 40 also may be coupled to target selection tool 44, which may include hardware and/or software for specifying profiles of students who will be targeted to receive SMS messages and web advertisements. Target selection tool 44 includes access rules database 54, which specifies the access level at which each university user may select demographics and/or notification interest categories for specifying profiles, and merchant and web advertiser may select demographics and/or advertisement interest categories for specifying profiles.

University interface 36, merchant interface 38 and web advertiser interface 40 also are coupled to target matching tool 48, which may include hardware and/or software for receiving the specified profiles, searching database 32 for students whose demographics and/or notification or advertisement interest categories match the specified profiles, predicting the number of matching students available to receive SMS messages at various timeslots, scheduling the timeslots for SMS message delivery, assigning web advertisement priorities, and sending targeted audience address information to SMS message tool 43 (for SMS messages) and web advertisement tool 46 (for web advertisements).

Database 32 may be a database stored on a hard disk, floppy disk, optical disk, or other similar computer memory. Database 32 may include a first database portion 50 that includes identifying data associated with each student, and a second database portion 52 that includes non-identifying data associated with each student. Persons of ordinary skill in the art will understand that first database portion 50 and second database portion 52 may be part of a single database, or may be included in separate databases.

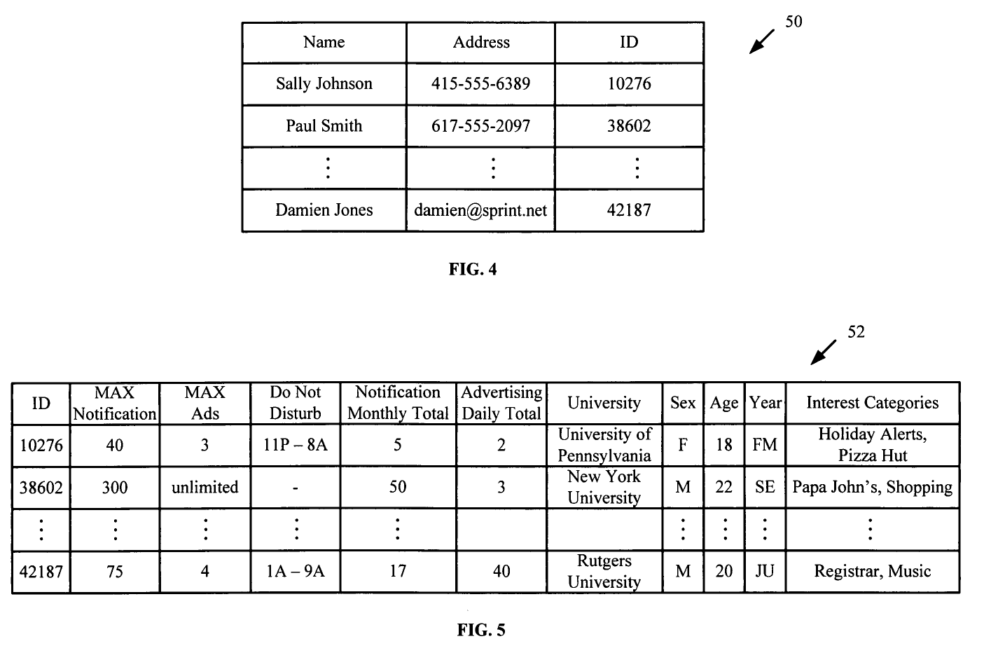

For example, as shown in FIG. 4, first database portion 50 may include one entry for each student, with each entry including identifying information associated with the student, such as the student's name and mobile device address (e.g., phone number, email address or other address information that uniquely identifies the student's mobile device 24), and a unique identification code (“ID”). The ID may be any alphanumeric code that may be uniquely associated with each student. As shown in FIG. 5, exemplary second database portion 52 also may include one entry per student, with each entry indexed by the student's ID. Each entry may include SMS preference information, SMS status information, demographic information and interest categories associated with a particular student.

Exemplary SMS preference information may include the maximum number of SMS notification messages that the student would like to receive in a given time period (e.g., per day, week, month, etc.), the maximum number of SMS advertisement messages that the student agrees to receive in a given time period (e.g., per day, week, month, etc.), do not disturb time intervals during which the student does not wish to receive SMS messages, or other similar SMS preference information that the student may specify. Exemplary SMS status information may include running totals of the number of SMS notification and advertisement messages that the student has received in the current notification and advertisement time periods, respectively, or other similar SMS status information. Exemplary demographic information may include the student's university name, sex, age, class year, or other similar demographic information. Exemplary interest categories may include notification interest categories and advertisement interest categories, described in more detail below.

As indicated in FIG. 5, a student associated with ID 10276 is an 18 year old female University Of Pennsylvania freshman who has agreed to receive at least 12 SMS advertisement messages per day, any time of day except 11 PM to 8 AM, and who has already received 3 SMS ads in the current day. In contrast, a student associated with ID 38602 is a 22 year old male New York University senior who has agreed to receive an unlimited number of SMS ads per day, any time of day, and who has already received 50 SMS ads in the current day.

Persons of ordinary skill in the art will understand that entries in first database portion 50 may include more or less than the exemplary categories of identifying information shown in FIG. 4, or may include alternative categories of identifying information. Persons of ordinary skill in the art will understand that entries in second database portion 52 may include more or less than the exemplary categories of non-identifying information shown in FIG. 5, or may include alternative categories of non-identifying information associated with each student.

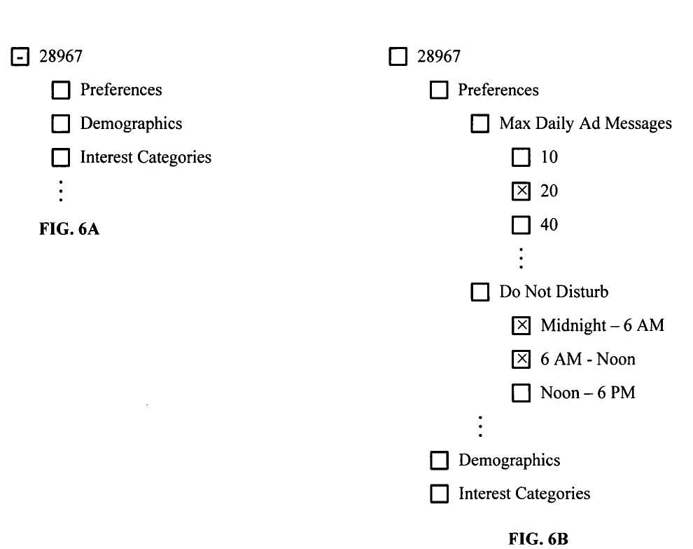

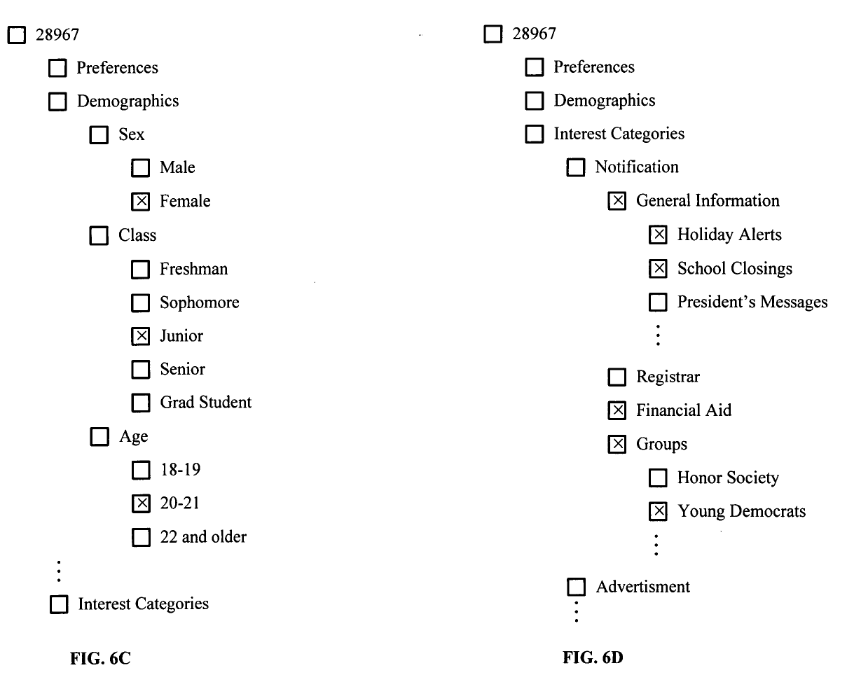

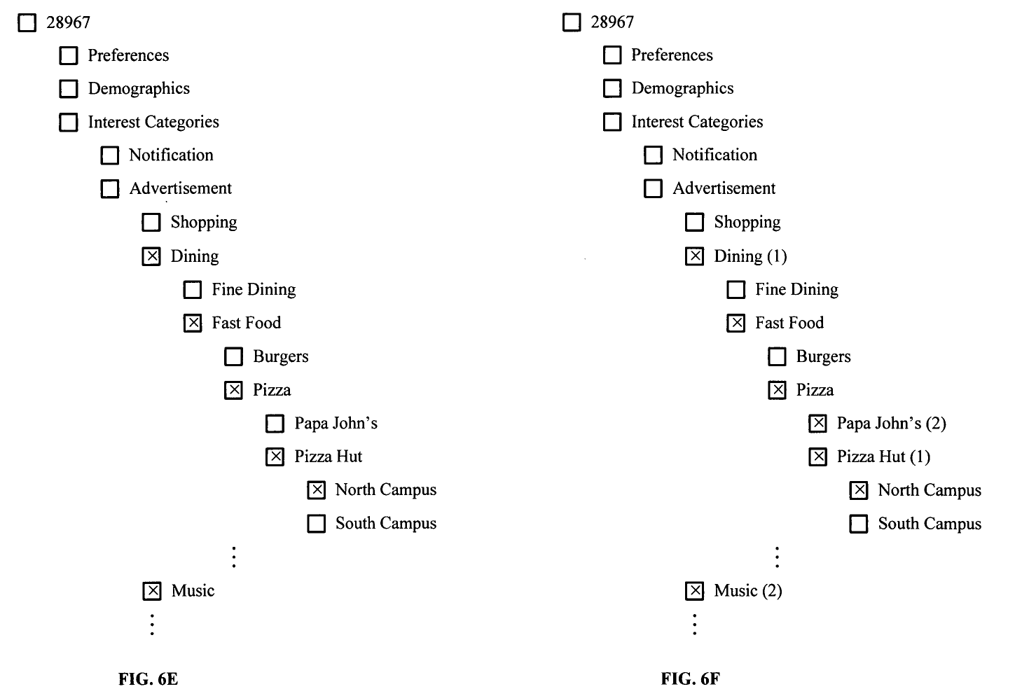

In addition, although FIG. 5 illustrates data shown in tabular format, the data in second database portion 52 may be represented in other formats. For example, FIG. 6 illustrates an alternative tree representation of data included in second database portion 52. For simplicity, only data associated with student ID 28967 are shown. Persons of ordinary skill in the art will understand that second database portion typically will include data associated with multiple student IDs.

Persons of ordinary skill in the art also will understand that the tree representation illustrated in FIG. 6 allows the data associated with each student to be displayed and sorted in a hierarchical fashion, from very general levels of detail to increasingly specific levels of detail. For example, as shown in FIG. 6A, the most general data level may include “Preferences,” “Demographics,” “Interest Categories” and other similar data categories. As shown in FIG. 6B, the Preferences category may include “Max Daily Ad Messages,” “Do Not Disturb” and other similar data subcategories. Thus, in the illustrated example, the student associated with student ID 28967 has elected to receive up to 20 SMS advertisement messages per day, and does not want to receive any SMS messages between midnight and noon. As shown in FIG. 6C, the Demographics category may include “Sex,” “Class,” “Age” and other similar data subcategories. Thus, in the illustrated example, the student associated with student ID 28967 is a female, junior who is 20-21 years old.

Persons of ordinary skill in the art will understand that the number of subcategory levels may be greater than two, and that any number of data items may be included within each subcategory. For example, as shown in FIG. 6D, Interest Categories may include “Notification” and “Advertisement” subcategories, with the Notification subcategory further including “General Information,” “Registrar,” “Financial Aid” and “Groups” subcategories, the General Information subcategory further including “Holiday Alerts,” “School Closings” and “President's Messages” subcategories, and the Groups subcategory further including “Honor Society” and “Young Democrats” subcategories. In the illustrated example, the student associated with student ID 28967 has elected to receive SMS notification messages related to Holiday Alerts, School Closings and Young Democrats, but has not elected to receive SMS notification messages related to President's Messages or Honor Society.

The exemplary tree structure illustrated in FIG. 6 may be organized such that a selection of a particular category also selects any subcategories that exist below the category. Thus, by selecting the Financial Aid subcategory, the student associated with student ID 28967 has elected to receive SMS notification messages related to Financial Aid, including any messages related to subcategories of Financial Aid. If a student would like to fine tune the interest category selection, the student may expand the category to show any subcategories, and may then deselect any of the subcategories about which the student is not interested.

As shown in FIG. 6E, the Advertisement subcategory may include “Shopping,” “Dining” and “Music” subcategories, with the Dining subcategory further including “Fine Dining” and “Fast Food” subcategories, the Fast Food subcategory further including “Burgers” and “Pizza” subcategories, the Pizza subcategory further including “Papa John's” and “Pizza Hut” subcategories, and the Pizza Hut subcategory further including “North Campus” and “South Campus” subcategories. As the example illustrates, the tree structure may be used to provide increasingly specific levels of detail regarding the student's Interest Categories. In this instance, the student associated with student ID 28967 is interested in receiving SMS advertisement messages related to fast food dining, specifically pizza and the North Campus Pizza Hut. In addition, the student is interested in receiving any SMS messages related to music.

In addition, each of the various subcategories in the Interest Categories may include weights or rankings to indicate the relative importance of the subcategories. For example, as shown in FIG. 6F, the student associated with student ID 28967 is interested in receiving SMS advertisement messages regarding Dining and Music, but has ranked Dining messages higher in importance than Music messages. In addition, within the Dining subcategory, the student has indicated that messages regarding Pizza Hut have higher priority than messages regarding Papa John's.

Referring again to FIG. 3, target selection tool 44 may be used by university users, merchants and web advertisers to specify profiles that may be used to identify students who will be targeted to receive SMS notification and advertisement messages (for university users and merchants, respectively) and web advertisements (for web advertisers). The specified profile may include one or more Demographics categories and/or Interest Categories. In addition, for merchants and web advertisers, the profile also may include one or more university identifiers (e.g., the university name). University users may use target selection tool 44 to specify profiles that include one or more Demographics categories and/or Notification Interest Categories, and merchants and web advertisers may use target selection tool 44 to specify profiles that include one or more Demographics categories, Advertisement Interest Categories and/or one or more university names.

Each university user, merchant and web advertiser may have an associated access level that may be stored in access rules database 54. The associated access level may be used to control the degree to which a university user, merchant or web advertiser may specify Demographics, Interest Categories and university names in a profile. For example, a university financial aid officer may have an associated access level that allows the user to specify a profile that includes the Financial Aid Notification Interest Category, but not General Information, Registrar or other Notification Interest Categories. Similarly, the secretary of the student French Club may have an associated access level that allows the user to specify a profile that includes a “French Club” Interest Category, but not General Information, Registrar or other Notification Interest Categories. In contrast, the university president may have access level that allows the president to specify a profile that includes any Notification Interest Category.

Merchants and web advertisers may have associated access levels that allow the user to specify profiles that include one or more Demographics, Advertisement Interest Categories and one or more universities. For example, a first merchant may have an associated access level that allows the merchant to specify profiles that include the most general level of Advertisement Interest Categories (e.g., Shopping, Dining, Music), but not more specific levels (e.g., Fast Food, Fine Dining, etc.). In contrast, a second merchant may have an associated access level that allows the merchant to specify profiles that include Demographics and any level of Advertisement Interest Categories. Similarly, a first web advertiser may have an associated access level that allows the advertiser to specify profiles that include only a single university, whereas a second web advertiser may have an associated access level that allows the advertiser to specify profiles that include multiple universities.

In this regard, merchants and web advertisers may be charged varying access level fees based on their associated access level. For example, because SMS advertisement messages may be more effective if they can be targeted to very specific students, a merchant may be charged a higher fee for an associated access level that allows the merchant to create profiles that include very detailed Demographics and Advertisement Interest Categories (e.g., male students who have selected “Pizza Hut, North Campus”). In contrast, other merchants may be satisfied with profiles that include less detailed Advertisement Interest Categories (e.g., “Fast Food”), and thus may be charged a lower access level fee. Likewise, a merchant that has an associated access level that allows the merchant to specify profiles that include multiple universities may be charged a higher fee than another merchant whose access level restricts the merchant to specify profiles at fewer universities.

Referring again to FIG. 3, target matching tool 48 may be used to search and extract student data from database 32 based on profiles specified by university users, merchants and web advertisers using university clients 28, merchant clients 14, and web advertiser clients 16, respectively. For example, a University of Pennsylvania financial aid officer may use a university client 28 and SMS message tool 42 to create a notification message regarding financial aid deadlines, and may use target selection tool 44 to specify a profile that includes the Financial Aid Notification Interest Category for University of Pennsylvania students. The officer may then use target matching tool 48 to extract from second database portion 52 the IDs of University of Pennsylvania students who have selected the Financial Aid Notification Interest Category.

Target matching tool 48 may use any of various techniques to perform matching between the Interest Categories included in a profile and the Interest Categories specified by a student. For example, target matching tool 48 may use Boolean “AND-type” matching, in which an exact match is required between a student's specified Interest Categories and the profile Interest Categories. Alternatively, other matching algorithms may be used, which may take into consideration weighting factors applied by students to their specified Interest Categories, and by university users, merchants and web advertisers to the Demographics and Interest Categories specified in the profiles.

For university users and merchants, target matching tool 48 may then display a calendar showing timeslots for sending the SMS notification message, and also may include predictions of the number of students who may be available to receive such messages in each timeslot. In this regard, target matching tool 48 may include software and/or hardware for calculating student availability predictions based on the number of students participating in the system, the maximum number of messages that each student has agreed to receive per time period, the actual number of messages that each student has already received in the current time period, the do not disturb settings for each student and other similar factors.

Target matching tool 48 may then allow the user to select one or more timeslots for message delivery, and specify a desired number of messages to send during the selected timeslots. For example, target matching tool 48 may allow the user to specify first and second timeslots, with the first timeslot being the primary timeslot for message delivery, and the second timeslot being an alternative timeslot for any SMS messages that are not delivered during the first timeslot.

Alternatively, target matching tool 48 may allocate timeslots using other techniques. For example, target matching tool 48 may implement an auction-type system for allocating timeslots. In this regard, merchants may place bids for particular timeslots, and target matching tool 48 may allocate the timeslots to the highest bidder. Alternatively, target matching tool 48 may allocate timeslots based on other criteria. For example, frequent users or other premium users may be awarded higher priority for timeslot allocation than other users. Additionally, target matching tool 48 may allow a user to pay a fee to prevent the user from being bumped from a specific timeslot, or pay a fee to bump another user from a previously reserved timeslot.

As mentioned above, target matching tool 48 may allow the user to specify a desired number of messages to send during the selected timeslots. Alternatively, for some users (e.g., university uses) target matching tool 48 may simply default to specifying that messages shall be sent to as many matching students as are available during the selected timeslots.

For web advertisers, target matching tool 48 may allow the user to specify a desired number of web advertisements to deliver, and assign an associated priority level to the web advertisement, with web advertisements displayed based on their priority level. Target matching tool 48 may assign priorities based on the order in which each web advertisement is received, or may use other techniques for assigning priorities. For example, target matching tool 48 may implement an auction-type system for allocating priorities. In this regard, web advertisers may place bids for priorities, and target matching tool 48 may allocate the highest priority to the highest bidder. Alternatively, target matching tool 48 may allocate priorities based on other criteria. For example frequent users or other premium users may be awarded higher priority for web advertisements than other users. Additionally, target matching tool 48 may allow a user to pay a fee to prevent the user's priority level from being decreased, or pay a fee to increase their priority level.

After a university user or merchant creates an SMS message, specifies a profile for the targeted audience, selects one or more delivery timeslots, and specifies the number of messages to send, target matching tool 48 may then save the profile in a database (not shown) for execution at the time specified in the selected timeslots. In particular, when the current time equals the specified time, target matching tool 48 may extract from second database portion 52 the IDs of students whose Demographics and/or Interest Categories match the profile. Without disclosing any student identifying information to the user, target matching tool 48 may then determine from first database portion 50 the address of each mobile device 24 associated with the extracted IDs, and may then send the determined addresses to SMS message tool 42, which may then format the messages for communication to the targeted mobile devices 24 via wireless interface 22.

For example, on a Monday morning, a merchant (e.g., Pizza Hut) may use a merchant client 14 and SMS message tool 42 to create an SMS advertisement message. The merchant may the use target selection tool 44 to specify a profile that includes the “Pizza Hut” category for Columbia University and Harvard University students, and may use target matching tool 48 to specify that 700 of the SMS advertisement messages should be delivered on the next Friday at 6:00 PM (first timeslot), with any remaining messages delivered on the same day at 7:00 PM (second timeslot). Target matching tool 48 may then save the profile in a database.

On Friday at 6:00 PM, target matching tool 48 may execute the profile, extracting from second database portion 52 the IDs of Columbia and Harvard students whose Advertisement Interest Categories include the “Pizza Hut” category. Target matching tool 48 may then determine from first database portion 50 the address of each mobile device 24 associated with the extracted IDs, and may then send the determined addresses to SMS message tool 42, which may then format the messages for communication to the targeted mobile devices 24 via wireless interface 22.

After a web advertiser creates a web advertisement, specifies a profile for the targeted audience, specifies the number of web advertisements to deliver, and selects a priority level, target matching tool 48 may then extract from second database portion 52 the IDs of students whose Demographics and/or Advertisement Interest Categories match the profile. Target matching tool 48 may then pass the matching IDs and the priority level to web advertising tool 46, which may monitor student interface 34 to determine when any student with a matching ID is logged onto the system. When a matching student is identified, web advertising tool 46 may provide the web advertisements for inserting in SMS system web pages displayed by student interface 34.

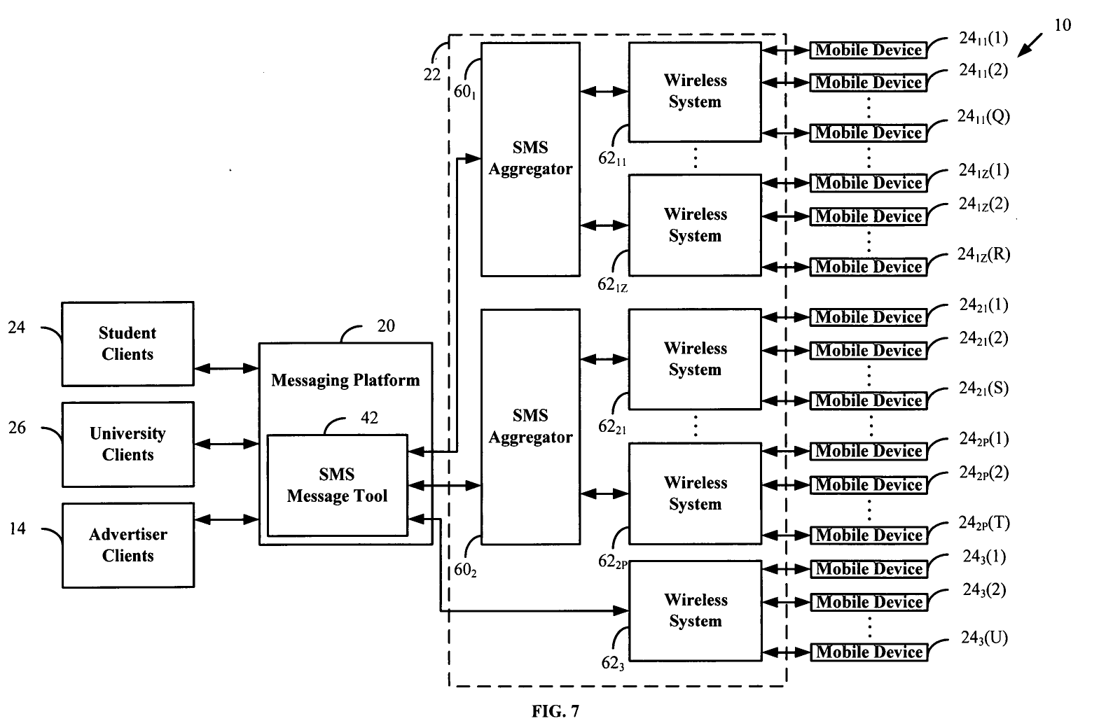

Referring now to FIG. 7, an exemplary wireless interface 22 is described. In particular, wireless interface 22 may include one or more SMS aggregators 60 and one or more wireless systems 62. As indicated in the diagram, SMS message tool 42 may send or receive SMS messages to and from mobiles devices 24 using SMS aggregators 60₁ and 60₂ via wireless systems 62₁ and 62₂, respectively, or directly via wireless system 62₃. SMS aggregators 60 are entities or services that provide a single gateway for sending and receiving SMS messages to and from mobile devices 24 on one or more wireless systems 62. For example, SMS aggregator 60, may be used to send and receive SMS messages to and from any of wireless systems 62₁₁, 62₁₂, . . . , 62_{1Z}, for delivery to or receipt from mobile devices 24₁₁(1), 24₁₁(2), . . . , 24₁₁(Q), . . . , and 24_{1Z}(1), 24_{1Z}(2), . . . , 24_{1Z}(R). Similarly, SMS aggregator 602 may be used to send and receive SMS messages to and from any of wireless systems 62₂₁, 62₂₂, . . . , 62_{2P}, for delivery to or receipt from mobile devices 24₂₁(1), 24₂₁(2), . . . , 24₂₁(S), . . . , and 24_{2P}(1), 24_{2P}(2), . . . , 24_{2P}(T). In addition, SMS message tool 42 may communicate directly with wireless system 623 for sending and receiving SMS messages to and from mobile devices 24₃(1), 24₃(2), . . . , 24₃(U).

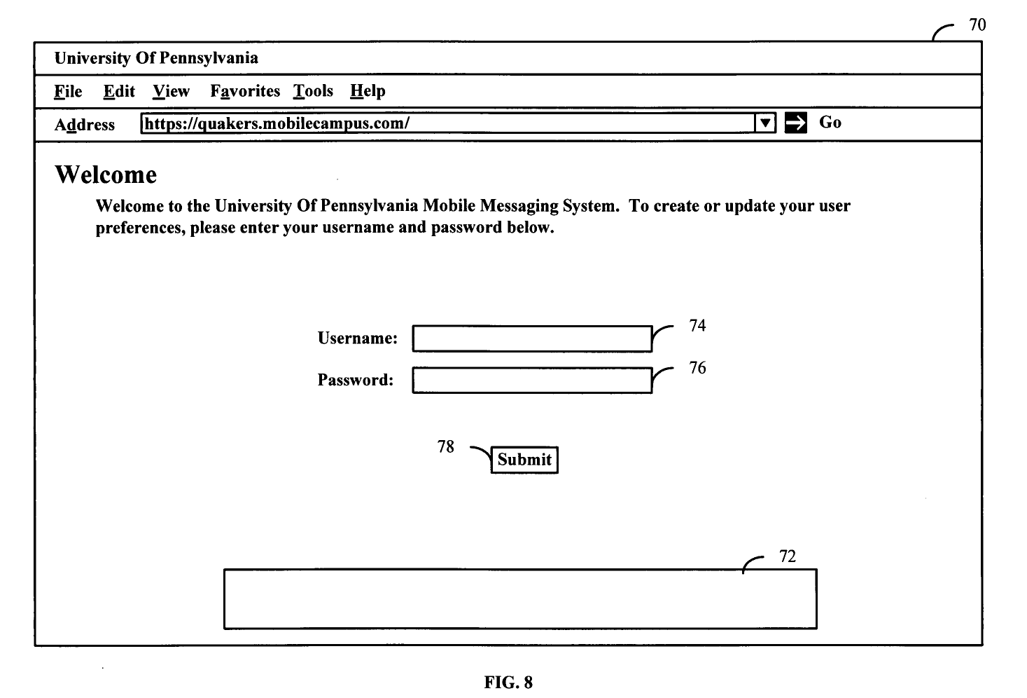

Referring again to FIG. 3, student interface 34 may host one or more SMS system web pages that a student may browse using a student client 26 to provide the student's mobile device 24 address, demographic information, SMS message preferences and Notification and Advertisement Interest Categories that are stored in database 32. For example, student interface 34 may host a sign-on web page 70, an example of which is illustrated in FIG. 8. Web page 70 may be associated with a uniform resource locator (URL) that may be conveniently associated with the student's university. For example, the URL may be in the form “mascot.mobilecampus.com,” where “mascot” is the university mascot. In the illustrated example, the URL is “quakers.mobilecampus.com.” In this regard, sign-on web pages may be customized to each individual university, and may include university names, logos, or other similar university indicia. Web page 70 also may include web advertising data, such as web advertisement 72, which may be created by a web advertiser in accordance with this invention.

Sign-on web page 70 may include data entry sections for entering a username 74 and password 76. The student may provide this information using a keyboard, mouse, pointing device, or other similar data entry device included in or associated with student client 26. To facilitate student acceptance and ease of use, the username and password may be the student's university email address and password, or other similar username and password that the student uses at the university. After the student enters this information and clicks a submit button 78, student interface 34 verifies the entered information.

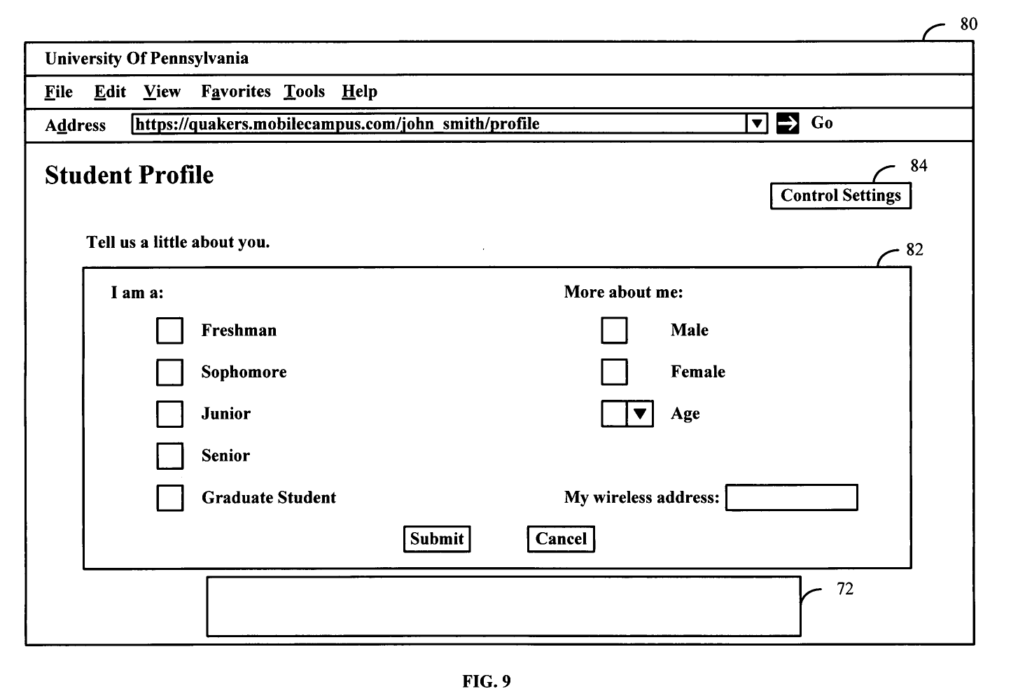

If the username and password are correct, student interface 34 may then display a student profile web page 80, an example of which is shown in FIG. 9. Student profile web page 80 may include a profile section 82 that a student may use to provide demographic information, such as class year (e.g., freshman, sophomore, etc.), sex, and age, and also specify the student's wireless address. Persons of ordinary skill in the art will understand that alternative techniques may be used to obtain the student's wireless address information. For example, student profile web page 80 may include a message instructing the student to use the student's mobile device 24 to send an SMS message that includes a predetermined code to a specific address associated with messaging platform 20. In this regard, student interface 34 may then obtain the student's wireless address information from the received SMS message.

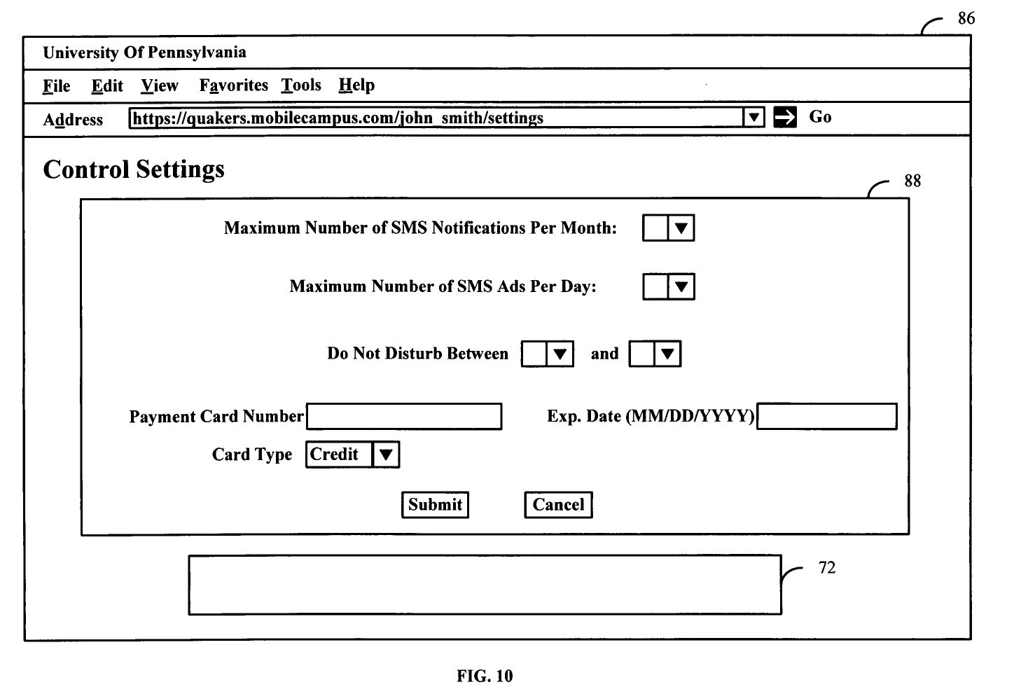

Student profile web page 80 also may include a control settings selection button 84. Upon selecting this button, student interface 34 may then display a control settings web page 86, an example of which is shown in FIG. 10. Control settings web page 86 may include a section 88 that a student may use to specify the maximum number of SMS notification messages that the student agrees to receive in a given time period (e.g., a month), the maximum number of SMS ads that the student agrees to receive in a given time period (e.g., a day), and also specify a “do not disturb” time period during which the student does not want to receive SMS notification or advertisement messages. Typically, each student may be required to receive a minimum number of ad messages in the given time period (e.g., at least 2 SMS ads per day). In addition, section 88 may include an optional section that allows a student to enter payment information for SMS e-commerce transactions. Student interface 34 may populate database 32 with information entered by students in web pages 80 and 86.

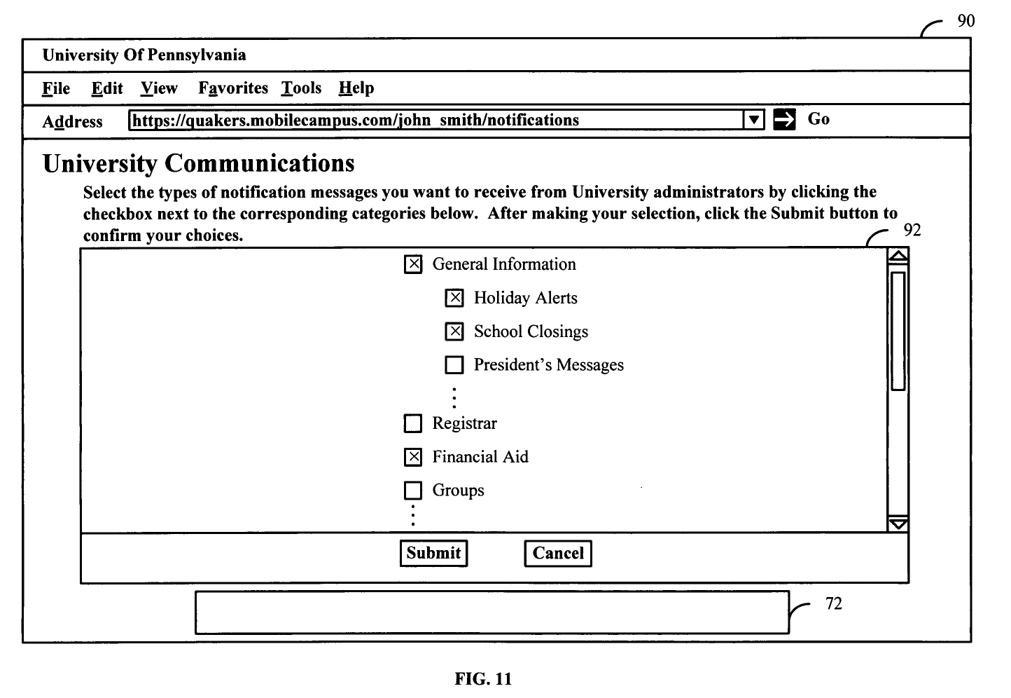

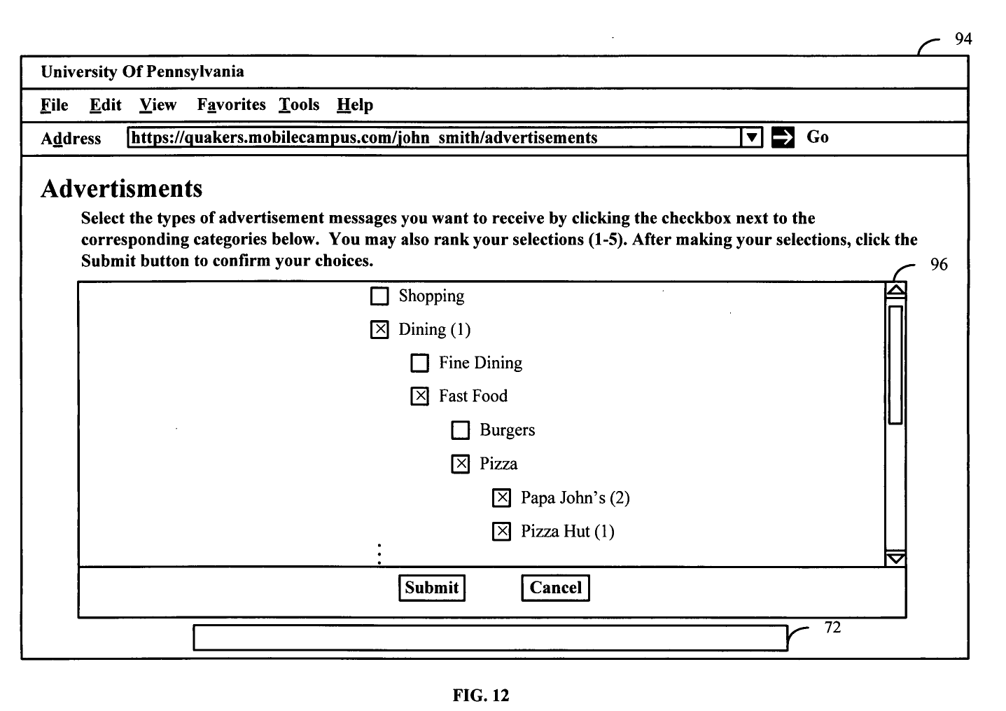

Referring again to FIG. 3, after receiving a student's demographic information and control settings selections, student interface 34 may then display a University Communications web page 90, such as the exemplary web page illustrated in FIG. 11. In particular, web page 90 may include a data entry section 92 that a student may use to specify the subject areas about which the student would like to receive SMS notification messages from university users. In the illustrated example, the student has elected to receive SMS notification messages related to “Holiday Alerts” and “School Closings,” but has not elected to receive SMS notification messages related to “President's Messages.” In addition, the student has elected to receive SMS notification messages related to “Financial Aid.”Referring again to FIG. 3, student interface 34 may next display an “Advertisements” web page 94, an example of which is shown in FIG. 12. In particular, web page 84 may include a data entry section 96 that a student may use to specify the subject areas about which the student would like to receive SMS advertisement messages from merchants. In the illustrated example, the student has elected to receive SMS advertisement messages related to dining, particularly fast food dining, and specifically from Papa John's and Pizza Hut.

University Communications web page 90 and Advertisements web page 94 also may allow a students to rank-order the selected categories. For example, as shown in FIG. 12, the student has assigned a rank of 1 to the Dining Category, and has assigned ranks of 2 and 1 to the Papa John's and Pizza Hut subcategories, respectively. Persons of ordinary skill in the art-will understand that other techniques may be used to prioritize the selected categories, such as using alphabetic scores, star-ratings, and other similar techniques.

As shown in FIGS. 8-12, student interface 34 may insert one or more web advertisements 72 in the exemplary SMS system web pages 70, 80, 86, 90 and 94. In this regard, messaging platform 20 may allow web advertisers to target web advertisements to specific students based on the students' specified Demographics and/or Advertisement Interest Categories. By so doing, messaging platform 20 allows web advertisers to more effectively provide web advertisements to students.

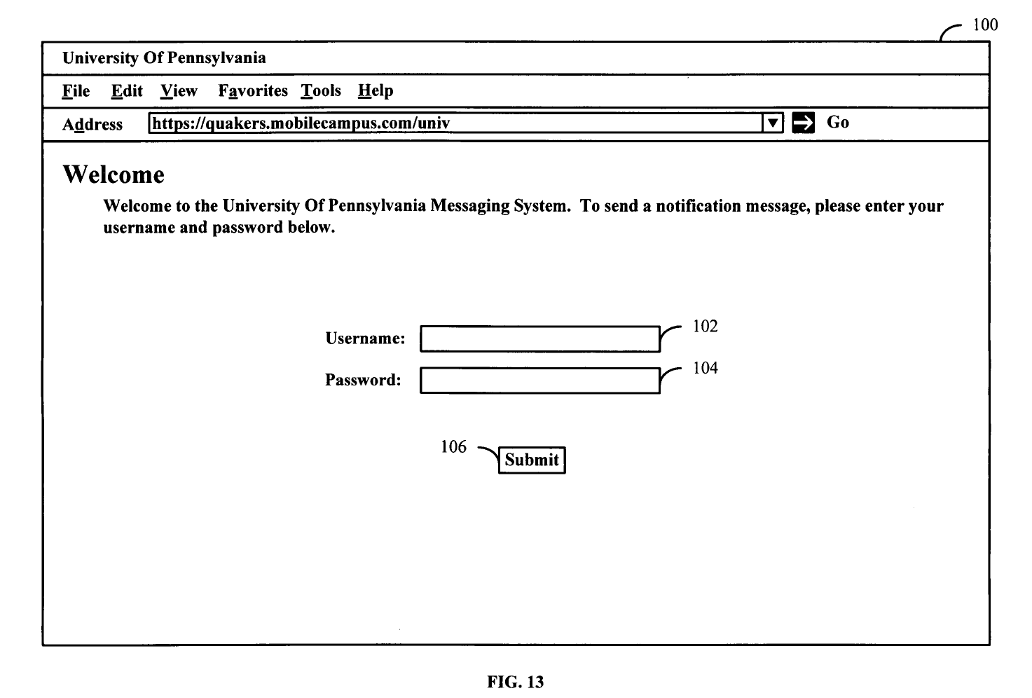

Referring again to FIG. 3, university web interface 36 may host one or more web pages that a university user may browse using a university client 28 to create notification SMS messages and select profiles of students who will receive such messages. For example, university web interface 36 may host a sign-on web page, an example of which is illustrated in FIG. 13. In particular, a university user may use a university client 28 to browse a sign-on web page 100 that includes data entry sections for entering a user name 102 and password 104. The university user may provide this information using a keyboard, mouse, pointing device, or other similar data entry device included in or associated with university client 28. After the university user enters this information and clicks a submit button 106, university web interface 36 verifies the entered information.

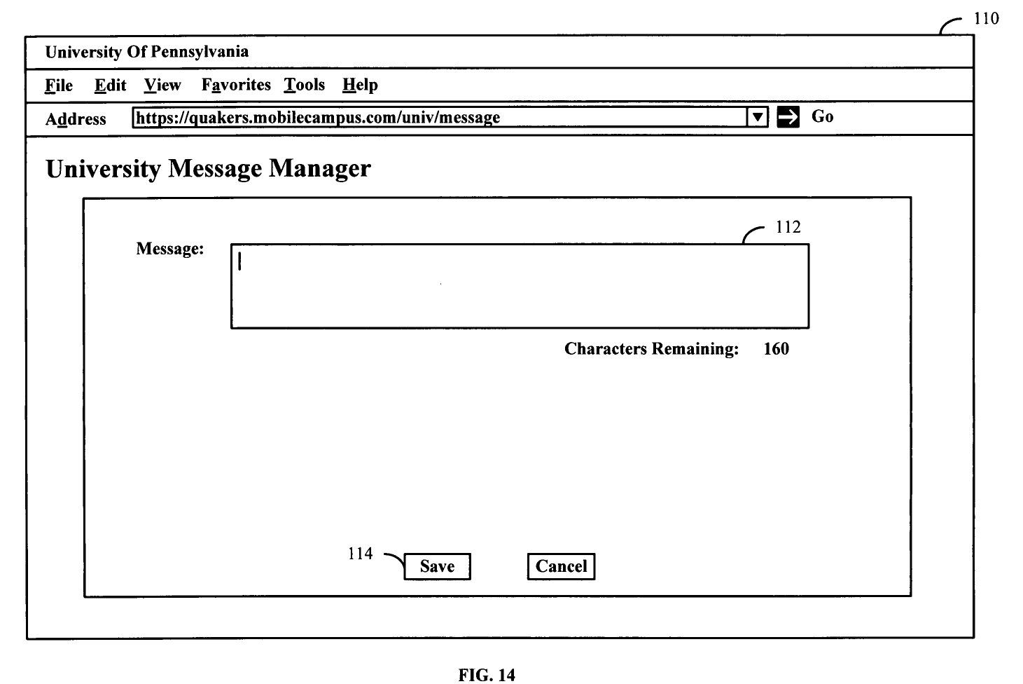

If the usemame and password are correct, university web interface 36 may then display a university message manager web page 110, an example of which is shown in FIG. 14. In particular, university message manager web page 110 may include a message entry section 112 that a university user may use to enter a notification message using SMS message tool 42. For example, a Registrar's Office employee may use a keyboard on university client 28 to type a text notification message informing students that transcripts are available. After completing the message, the university user may then click the Save button 114 to save the message.

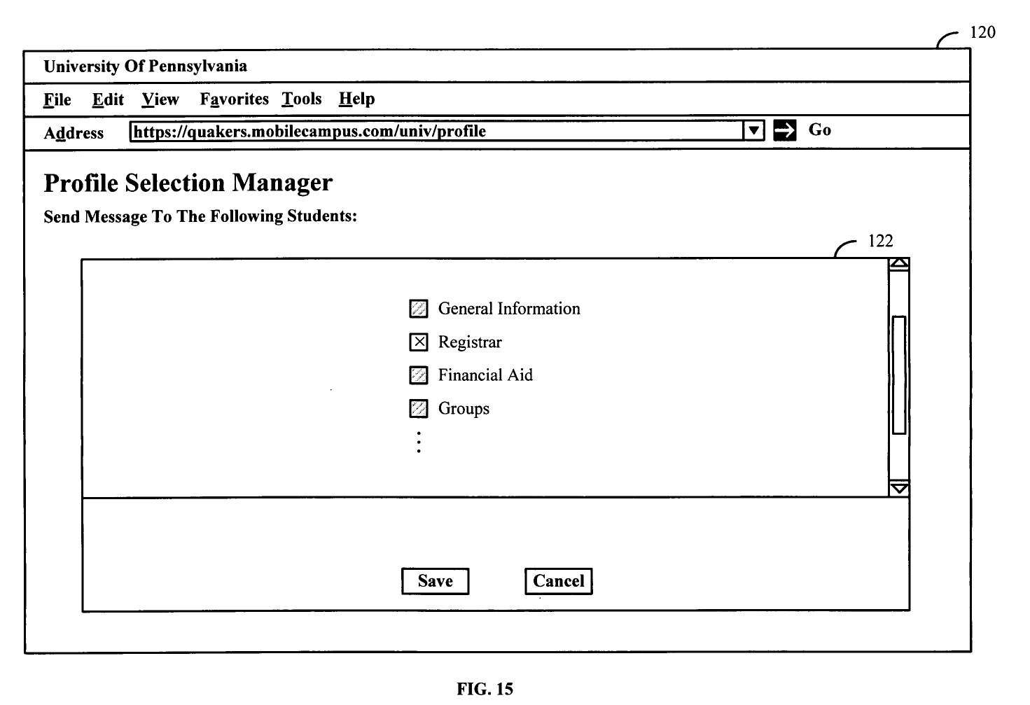

University web interface 36 may then display a profile selection web page 120, an example of which is shown in FIG. 15. In particular, profile selection web page 120 may include a profile selection section 122 that a university user may use to specify a profile using target selection tool 44. Target selection tool 44 may determine the university user's access level from access rules database 54, and may then display the corresponding Demographics and/or Notification Interest Categories that the university user may select.

For example, target selection tool 44 may display only the Interest Categories that the university user may select, or may display all of the Notification Interest Categories, with the unavailable Interest Categories grayed out, such as in FIG. 15. In this example, the university user has specified that she wants to target students who have selected the Registrar Interest Category.

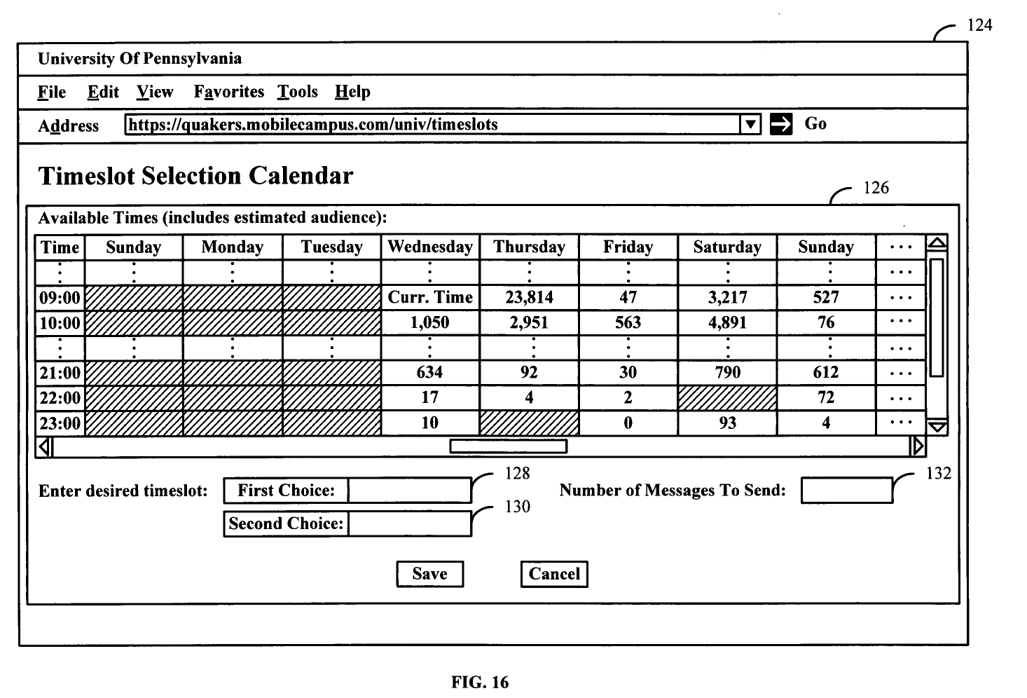

After the university user specifies the profile, target matching tool 48 extracts from second database portion 52 the IDs of the university's students who have selected the Registrar Notification Interest Category, and then displays a calendar showing timeslots that may be available for sending the SMS notification message. As mentioned above, target matching tool 48 may include in the calendar predictions of the number of students who match the specified profile and who may be available to receive such messages in each timeslot. An exemplary timeslot selection calendar is illustrated in FIG. 16. In the illustrated example, 563 matching students may be available on Friday at 10:00 AM, whereas 23,814 matching students may be available on Thursday at 9:00 AM.

Timeslot selection web page 124 may include a timeslot selection section 126 that a university user may use to select one or more timeslots for delivering the SMS notification message. For example, the university user may select a first timeslot in first choice section 128 and a second timeslot in second choice section 130. In the illustrated example, unavailable timeslots are indicated in cross-hatching. In addition, timeslot selection web page 124 optionally may include a section 132 for specifying the total number of SMS messages to send during the selected timeslots.

Target matching tool 48 may then save the profile in a database for execution at the time specified in the selected timeslots. In particular, when the current time equals the specified time, target matching tool 48 may extract from second database portion 52 the IDs of students whose Demographics and/or Interest Categories match the profile and who are available to receive SMS messages. If the number of available matching IDs is less than or equal to the total number of messages to be sent as specified by the university user, all of the IDs are extracted. If the number of available matching IDs exceeds the total, only that number of IDs are extracted.

Target matching tool 48 may then determine from first database portion 50 the address of each mobile device 24 associated with the extracted IDs, and may then send the determined addresses to SMS message tool 42, which may then format the messages for communication to the targeted mobile devices 24 via wireless interface 22. If the number of available matching IDs was less than the total number of messages to be sent as specified by the university user, target matching tool 48 may attempt to send the remaining number of messages during any selected subsequent timeslots.

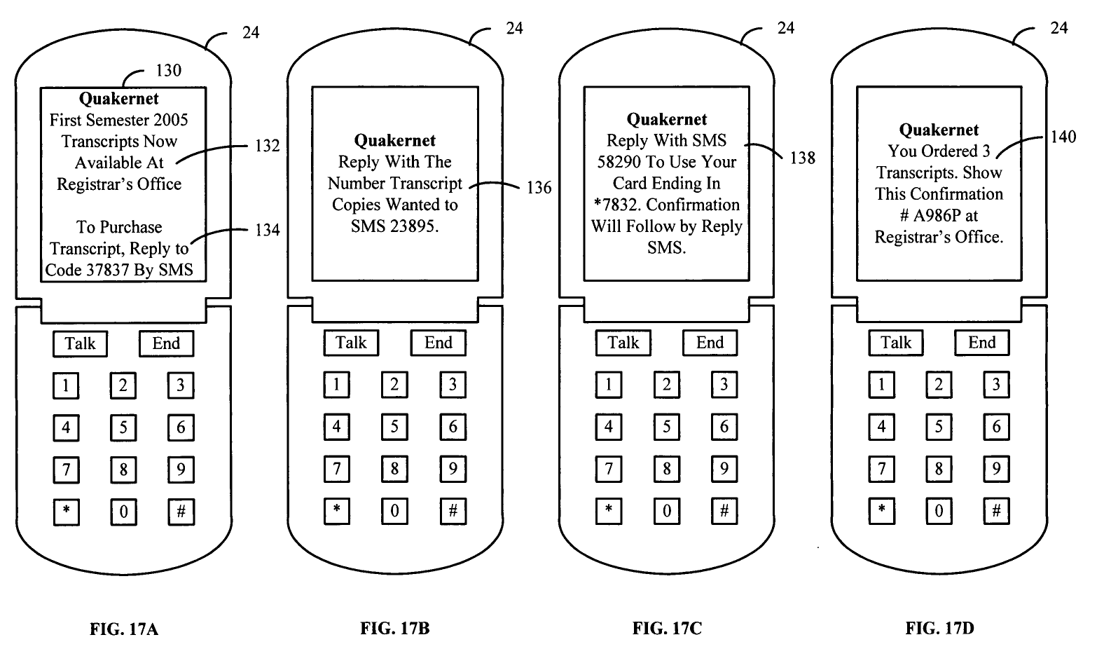

Referring now to FIG. 17, an exemplary SMS notification message displayed on a student Mobile Device 24 is described. In particular, as shown in FIG. 17A, Mobile Device 24 may include a display 130 on which a received SMS notification message 132 may appear. For example, the SMS notification message 132 may be a message from the Registrar's Office, notifying the student that transcripts are now available. In addition, SMS notification message 132 may include a message portion 134 indicating that the student may purchase copies of her transcript by responding to a first code with a reply SMS message. For example, referring again to FIG. 3, SMS message tool 42 may include an e-commerce engine (not shown) that inserts the code into message portion 134.

As shown in FIG. 17B, if the student replies to the specified code, the e-commerce engine in SMS message tool 42 may send an SMS message 136 to the student's Mobile Device 24 requesting that the student enter the desired number of copies by responding to a second code with a reply SMS message. As shown in FIG. 17C, after receiving the desired number of copies, the e-commerce engine in SMS message tool 42 may send an SMS message 138 to the student's Mobile Device 24 requesting that the student confirm that the fee for the transcripts should be charged to the student's payment card (e.g., credit card, debit card, etc.) on file by responding to a third code with a reply SMS message. Next, after verifying the student's payment card information, the e-commerce engine in SMS message tool 42 may forward details of the order to the Registrar (e.g., via an email message), and may send a confirmation SMS message 140 to the student's Mobile Device 24, along with instructions for obtaining the ordered transcripts.

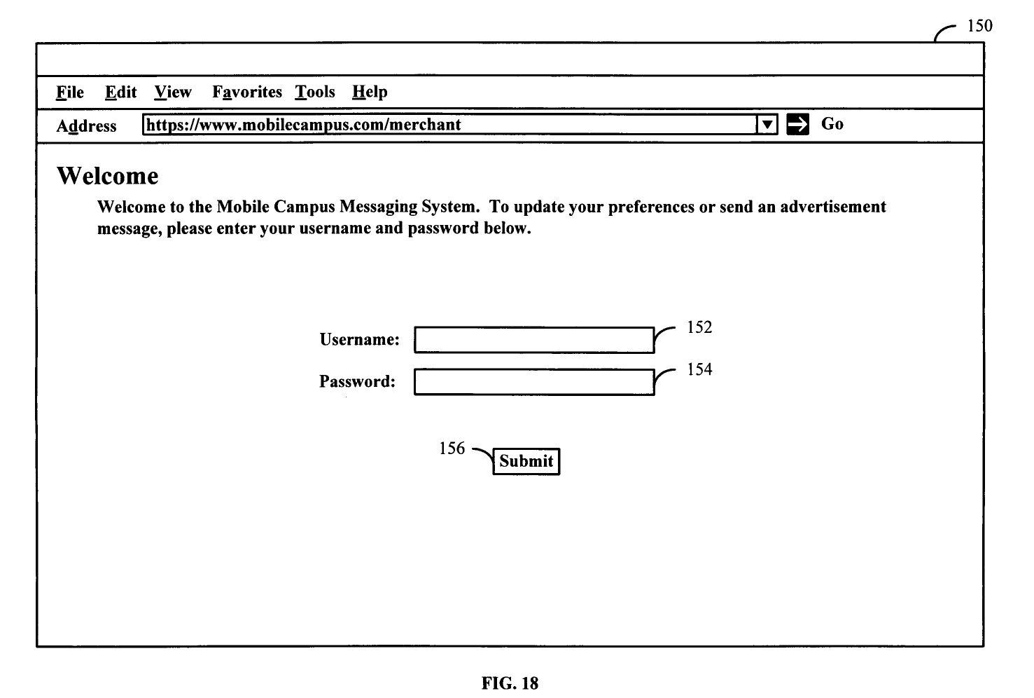

Referring again to FIG. 3, merchant web interface 38 may host one or more web pages that a merchant may browse using a merchant client 14 to establish a merchant account, select access levels and messaging plans, create advertisement SMS messages and select profiles of students who will receive such messages. For example, merchant web interface 38 may host a sign-on web page, an example of which is illustrated in FIG. 18. In particular, a merchant may use a merchant client 14 to browse a sign-on web page 150 that includes data entry sections for entering a user name 152 and password 154. The merchant may provide this information using a keyboard, mouse, pointing device, or other similar data entry device included in or associated with merchant client 14. After the merchant enters this information and clicks a submit button 156, merchant web interface 38 verifies the entered information.

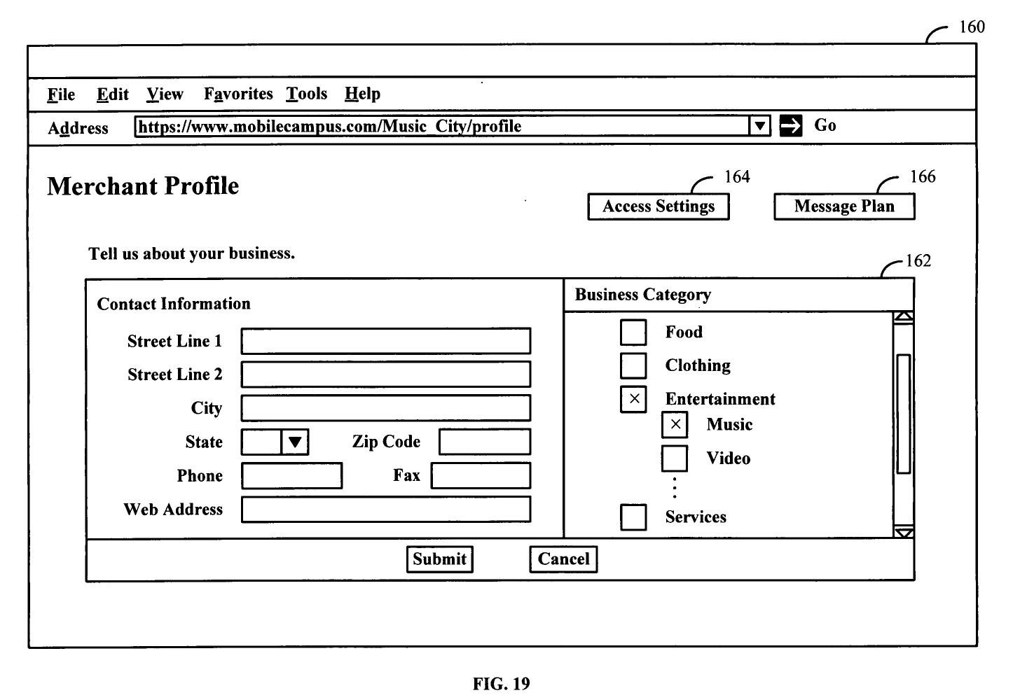

If the username and password are correct, merchant web interface 38 may then display a merchant profile web page 160, an example of which is shown in FIG. 19. Merchant profile web page 160 may include a profile section 162 that a merchant may use to provide contact information (e.g., address, phone and fax numbers, web site address, etc.) and business demographic information (e.g., food, clothing, entertainment, sports, etc.). Merchant profile web page 160 also may include an access settings selection button 164 and a message plan selection button 166.

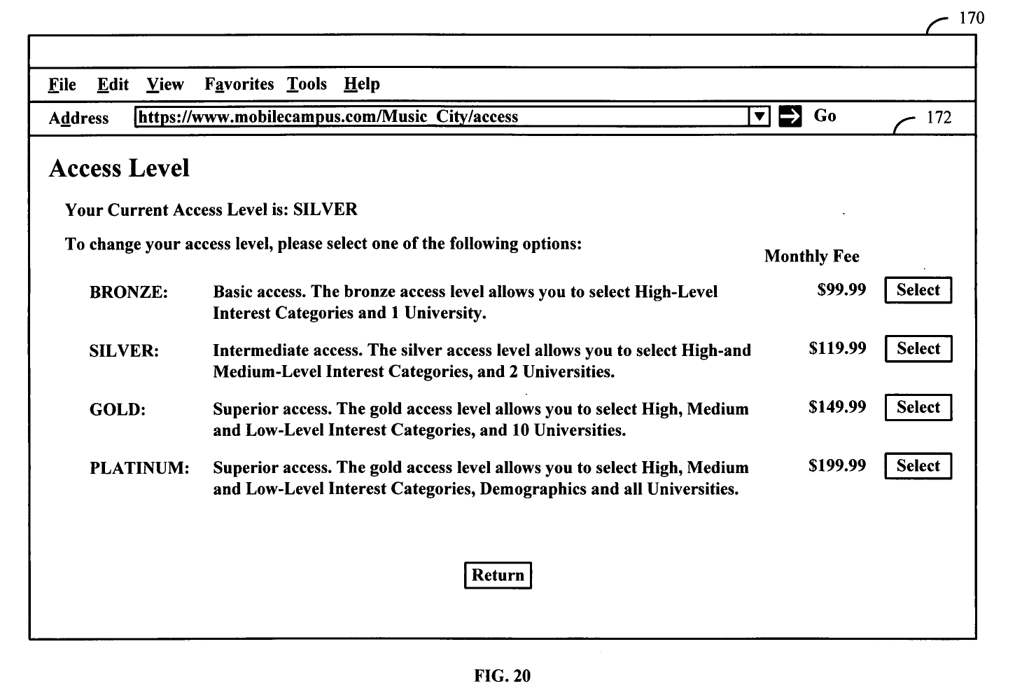

Upon selecting the access settings button 164, merchant interface 38 may then display an access level web page 170, an example of which is shown in FIG. 20. Access level web page 170 may include a section 172 that allows a merchant to select from various access level plans that allow the merchant to specify profiles for targeted SMS advertisement messages. For example, a basic access level plan may allow the merchant to specify profiles that include the most general level of Advertisement Interest Categories (e.g., Shopping, Dining, Music), but not more specific levels (e.g., Fast Food, Fine Dining, etc.), and that include only one university. An intermediate access level plan may allow a merchant to specify profiles that include higher levels of Advertisement Interest Categories, and include multiple universities. The highest access level plan may allow a merchant to specify profiles that include all levels of Advertisement Interest Categories, Demographics, and include all universities.

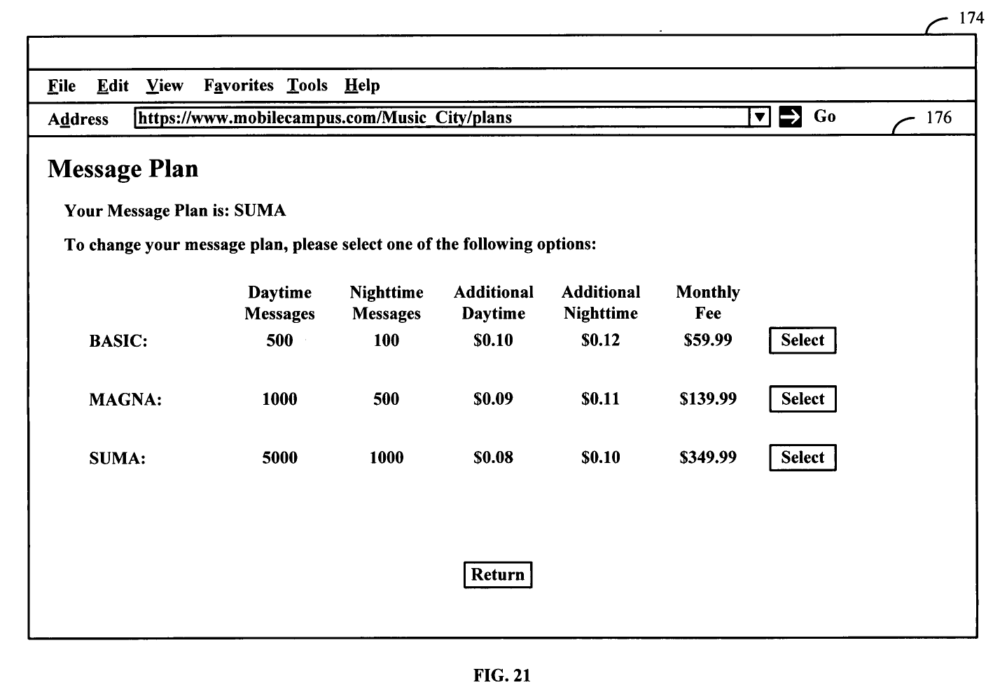

Referring again to FIG. 19, upon selecting the message plans button 166, merchant interface 38 may then display a message plans web page 174, an example of which is shown in FIG. 21. Message plans web page 174 may include a section 176 that allows a merchant to select from various message plans. Each message plan may include bundled messages, such as a daytime bundle and a night/weekend bundle. Each message plan also may include additional message fees that apply for each message that is sent after the merchant exhausts the message bundle. In this regard, the message plans may be similar to wireless telephone message plans. Persons of ordinary skill in the art will understand, however, that other types of message plans also may be used, and that plans may be customized to individual merchants. For example, a large national retailer may negotiate a customized message plan for all of the retailer's outlets throughout a country or region.

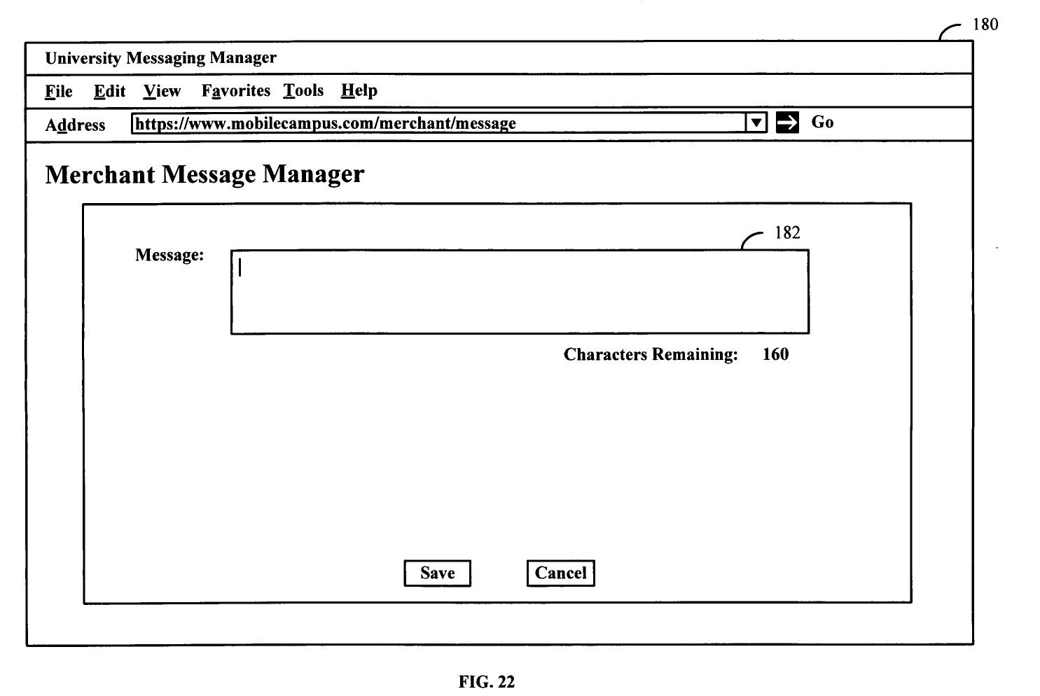

Referring again to FIG. 3, after receiving a merchant's profile information, merchant web interface 38 may then display a merchant message manager web page 180, an example of which is shown in FIG. 22. In particular, merchant message manager web page 190 may include a message entry section 182 that a merchant may use to enter an advertisement message using SMS message tool 42. For example, a merchant may use a mouse on merchant client 14 to select and attach a multimedia file that includes a video advertisement for a local restaurant. After completing the message, the merchant may then click the Save button to save the message.

Merchant web interface 38 may then display a profile selection web page 190, an example of which is shown in FIG. 23. In particular, profile selection web page 190 may include a profile selection section 192 that a merchant may use to specify a profile using target selection tool 44. Target selection tool 44 may determine the merchant's access level from access rules database 54, and may then display the corresponding Demographics and/or Advertisement Interest Categories that the merchant may select.

For example, target selection tool 44 may display only the Interest Categories that the merchant may select, or may display all of the Advertisement Interest Categories, with the unavailable Interest Categories grayed out, such as in FIG. 23. In addition, target selection tool 44 may display a first profile selection section 194 that may be used to specify Demographics and/or Advertisement Interest Categories, and a second profile selection section 196 that may be used to specify universities. In this example, the merchant has specified that she wants to target Boston University and Drexel University students who have selected “Dining,” “Fast Food,” “Pizza,” and “Pizza Hut” Interest Categories.

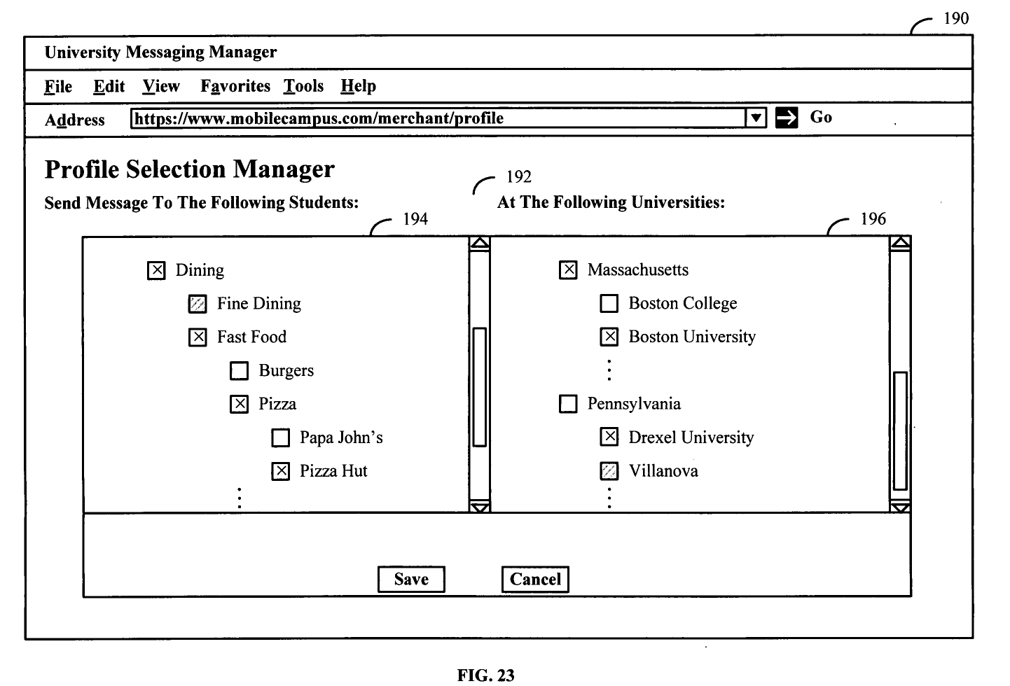

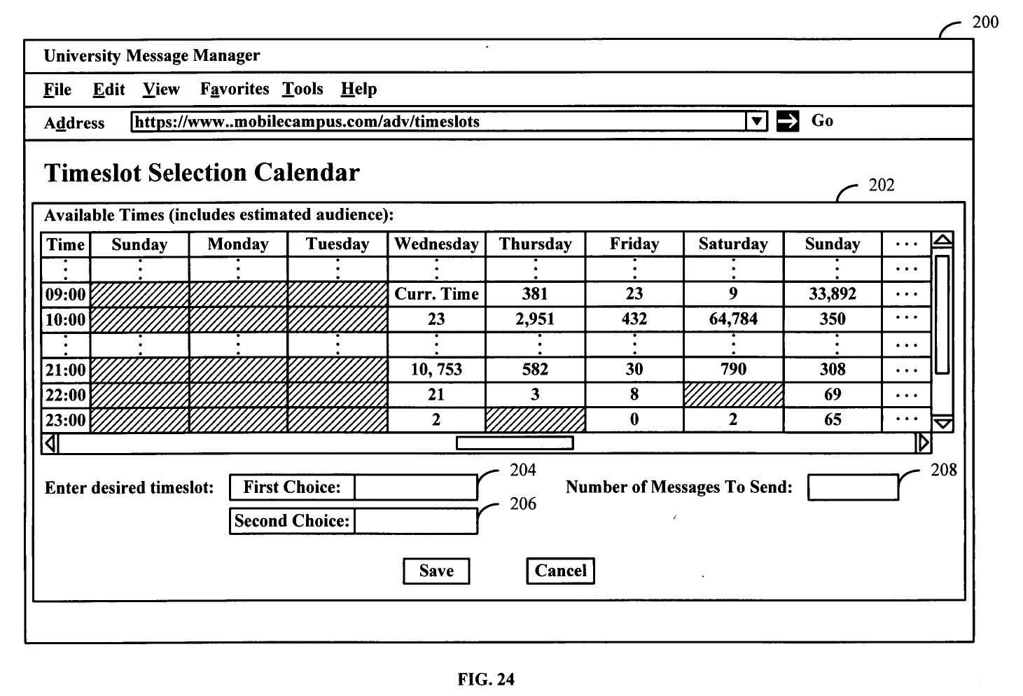

After the merchant specifies the profile, target matching tool 48 extracts from second database portion 52 the IDs of the students at the specified universities who have matching Demographics and/or Advertisement Notification Interest Categories, and then displays a calendar showing timeslots for sending the SMS notification message. As mentioned above, target matching tool 48 also may include in the calendar predictions of the number of students who match the specified profile and who may be available to receive such messages in each timeslot. An exemplary timeslot selection calendar is illustrated in FIG. 24. In the illustrated example, 64,874 matching students may be available on Saturday at 10:00 AM, whereas no matching students may be available on Friday at 11:00 PM.

Timeslot selection web page 200 may include a timeslot selection section 202 that a merchant may use to select one or more timeslots for delivering the SMS advertisement message. For example, the merchant may select a first timeslot in first choice section 204 and a second timeslot in second choice section 206. In the illustrated example, unavailable timeslots are indicated in cross-hatching. In addition, timeslot selection web page 200 may include a section 208 for specifying the total number of SMS messages to send during the selected timeslots.

As mentioned above, timeslots also may be allocated using other techniques, such as auctions. For example, target matching tool 48 may implement an auction-type system for allocating timeslots, and merchants may place bids for particular timeslots. In this regard, timeslot selection section 202 may include a section that allows a merchant to submit and monitor bids for particular timeslots, pay a fee to prevent the merchant from being bumped from a specific timeslot, or pay a fee to bump another user from a previously reserved timeslot.

After timeslot selection is completed, target matching tool 48 may then save the profile in a database for execution at the time specified in the selected timeslots. In particular, when the current time equals the specified time, target matching tool 48 may extract from second database portion 52 the IDs of students whose Demographics and/or Interest Categories match the profile and who are available. If the number of available matching IDs is less than or equal to the total number of messages to be sent as specified by the merchant, all of the IDs are extracted. If the number of available matching IDs exceeds the total, only that number of IDs are extracted.

Target matching tool 48 may then determine from first database portion 50 the address of each mobile device 24 associated with the extracted IDs, and may then send the determined addresses to SMS message tool 42, which may then format the messages for communication to the targeted mobile devices 24 via wireless interface 25. If the number of available matching IDs was less than the total number of messages to be sent as specified by the merchant, target matching tool 48 may attempt to send the remaining number of messages during any selected subsequent timeslots.

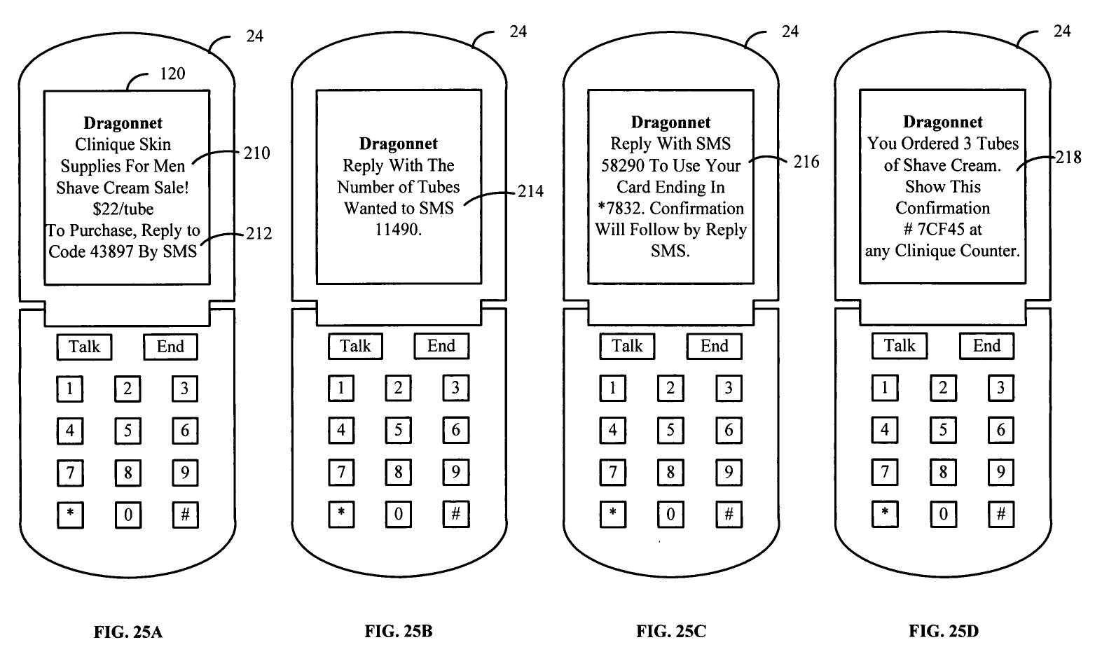

Referring now to FIG. 25, an exemplary SMS advertisement message displayed on a student Mobile Device 24 is described. In particular, as shown in FIG. 25A, Mobile Device 24 may display a received SMS advertisement message 210. For example, the SMS notification message 210 may be a message from a cosmetics company, notifying the student that a particular skin care product is on sale. In addition, SMS notification message 210 may include a message portion 212 indicating that the student may purchase the skin care product by responding to a first code with a reply SMS message. For example, referring again to FIG. 3, SMS message tool 42 may include an e-commerce engine (not shown) that may insert the code into message portion 212.

As shown in FIG. 25B, if the student replies to the specified code, the e-commerce engine in SMS message tool 42 may send an SMS message 214 to the student's Mobile Device 24 requesting that the student enter the desired quantity of skin care product by responding to a second code with a reply SMS message. As shown in FIG. 25C, after receiving the desired quantity, the e-commerce engine in SMS message tool 42 may send an SMS message 216 to the student's Mobile Device 24 requesting that the student confirm that fee for the products should be charged to the student's payment card (e.g., credit card, debit card, etc.) on file by responding to a third code with a reply SMS message. Next, after confirming the student's payment card information, the e-commerce engine in SMS message tool 42 may forward details of the order to the advertiser (e.g., via an email message), and may send a confirmation SMS message 218 to the student's Mobile Device 24, along with instructions for obtaining the ordered product.

Referring again to FIG. 3, persons of ordinary skill in the art will understand that web advertiser interface 40 may host one or more web pages that a web advertiser may browse using a web advertiser client 16 to establish a web advertiser account, select access levels and web advertisement plans, create web advertisements and select profiles of students who will receive such advertisements, similar to the web pages that merchant interface 38 hosts and as described above with respect to FIGS. 18-21 and 23. In addition, web advertiser interface 40 may include a web advertisement queue (not shown) that may be used to hold for screening by a system operator. If the system operator approves the web advertisement, the ad may be queued for delivery.

In addition, university web interface 36, merchant web interface 38 and advertiser web interface 40 each may host additional web pages that university users, merchants and advertisers may browse using university clients 28, merchant clients 14 and advertiser clients 16, respectively, to extract non-identifying data from second database portion 52 of database 32. For example, university web interface 36 may host a web page that allows a university user to request the number of students who have elected to receive notification SMS messages regarding financial aid. After receiving the request, university web interface 36 may use target matching tool 48 to extract the requested information from database 32, and may then display the extracted information in the university user's web browser. Similarly, merchant web interface 38 may host-a web page that allows a merchant to request the number of students at a particular university who are interested in a particular Advertisement Interest Category (e.g., wine). After receiving the request, merchant web interface 38 may use target matching tool 48 to extract the requested information from database 32, and may then display the extracted information to the advertiser's web browser.

Persons of ordinary skill in the art will understand that the various components of exemplary SMS system 10 may be owned by various persons or entities, and that various fees may be charged for use of the system. For example, messaging platform 20 may be owned and operated by a first entity, and student clients 26, university clients 28, merchant clients 14, advertiser clients 16 and wireless interface 22 may be owned and/or operated by one or more distinct entities. An owner of messaging platform 20 may charge university users a first fee for sending and receiving SMS notification messages to students' mobile devices 24, may charge merchants a second fee for sending and receiving SMS advertisement messages to students' mobile devices 24, and may charge web advertisers a third fee for displaying web advertisements on student clients 26.

The first fee may be free, and the second fee may be a predetermined cost per SMS advertisement message (e.g., 12 cents per SMS advertisement message), or may be a flat fee for a predetermined number of advertisement messages (e.g., $1,000 for the first 100 messages, and $0.10/message for each message above 100 messages). The third fee may be a predetermined cost per web advertisement (e.g., 6 cents per we advertisement), or may be a flat fee for a predetermined number of web advertisements (e.g., $1,000 for the first 500 web advertisement, and $0.02/web advertisement for each web advertisement above 100 ads).

The second and third fees may be flat fees, or may be adjustable-rate fees that may be varied based on time of day, day of week, or other similar factors. For example, the SMS advertisement message fees may be divided into multiple time-based rates, such as daytime and night/weekend billing rates. Additionally, the SMS advertisement message fees may vary based on the day of the week, the day of the month, and other similar factors. For example, premium rates may apply on days during which football games are held on campus, or during final exam periods. Moreover, varying fee structures may apply based on factors such as the type of business, the volume of messages being sent, the flexibility of the time periods for message delivery and other similar factors.

Because a university may be reluctant to implement SMS notification systems because of concerns about the cost of implementing and using such systems, an owner of messaging platform 20 may allow a university to use SMS system 10 for no cost, and/or may pay the university a singing bonus to use and endorse such a system. To encourage students to use SMS systems in accordance with this invention, an owner of messaging platform 20 may allow students to receive SMS notification messages from university users for no cost, in exchange for agreeing to receive a minimum number of SMS advertisement messages in a given time period. For example, each student may be required to accept at least 10 SMS advertisement messages from merchants per day.

The foregoing merely illustrates the principles of this invention, and various modifications can be made by persons of ordinary skill in the art without departing from the scope of this invention.

1. A communication system for a university community comprising a plurality of university users and students, each student having a mobile device adapted to receive SMS messages and a client device adapted to browse web pages, the communication system comprising:
a messaging platform coupled to the university users, the students, a merchant and a web advertiser, the messaging platform adapted to allow:
each student to specify associated notification and advertisement interest categories;
each university user to create and send SMS notification messages to the mobile devices of the students based on the students' specified notification interest categories;
the merchant to create and send SMS advertisement messages to the mobile devices of the students based on the students' specified advertisement interest categories; and
the web advertiser to display web advertisements in the web pages based on the students' specified advertisement interest categories.

2. The communication system of claim 1, wherein the mobile devices comprise any of a pager, personal digital assistant, cell phone, wireless handheld device, personal computer, laptop computer and handheld computer.

3. The communication system of claim 1, wherein the SMS messages comprise short messages.

4. The communication system of claim 1, wherein the SMS messages comprise multimedia messages.

5. The communication system of claim 1, wherein the messaging platform is further adapted to allow each student to select preferences regarding the SMS messages that the student would like to receive.

6. The communication system of claim 5, wherein the options comprise quantities of SMS advertisement messages in a specified time period.

7. The communications system of claim 1, wherein the SMS notification messages comprise any of schedule information, class cancellation information, course enrollment information, university sports information, and general university information.

8. The communications system of claim 1, wherein the SMS advertisement messages comprise information regarding local businesses.

9. The communications system of claim 1, wherein the SMS advertisement messages comprise information regarding national businesses.

10. The communications system of claim 1, wherein the SMS advertisement messages comprise a discount coupon.

11. The communications system of claim 1, wherein the messaging platform is further adapted to receive SMS reply messages from the students.

12. The communications system of claim 1, wherein the messaging platform is further adapted to allow the university users and the students to conduct electronic commerce via SMS notification messages.

13. The communications system of claim 1, wherein the messaging platform is further adapted to allow the merchants and the students to conduct electronic commerce via SMS advertisement messages.

14. A communication system for providing merchants with access to a plurality of students at a plurality of universities, each university comprising a plurality of university users and a plurality of associated students, each student having a mobile device adapted to receive SMS messages, the method comprising:
providing a messaging platform coupled to university users, the students and the merchants, the messaging platform adapted to allow the university users to send SMS notification messages to their associated students, and allow the merchants to send SMS advertisement messages to students at one or more universities.

15. The communication system of claim 14, wherein the mobile devices comprise any of a pager, personal digital assistant, cell phone, wireless handheld device, personal computer, laptop computer and handheld computer.

16. The communication system of claim 14, wherein the SMS messages comprise short messages.

17. The communication system of claim 14, wherein the SMS messages comprise multimedia messages.

18. The communication system of claim 14, wherein the messaging platform is adapted to allow each student to select options regarding the SMS messages that the student would like to receive.

19. The communication system of claim 18, wherein the options comprise interest categories.

20. The communication system of claim 18, wherein the options comprise quantities of SMS advertisements in a specified time period.

21. The communication system of claim 14, wherein the notification messages comprise any of schedule information, class cancellation information, course enrollment information, university sports information, and general university information.

22. The communication system of claim 14, wherein the SMS advertisement messages comprise information regarding local businesses.

23. The communication system of claim 14, wherein the SMS advertisement messages comprise information regarding national businesses.

24. The communication system of claim 14, wherein the SMS advertisement messages comprise a discount coupon.

25. The communication system of claim 14, wherein the messaging platform is further adapted to receive SMS reply messages from the students.

26. The communication system of claim 14, wherein the messaging platform is further adapted to allow the university users and their associated students to conduct electronic commerce via SMS notification messages.

27. The communication system of claim 14, wherein the messaging platform is further adapted to allow the advertisers and the students to conduct electronic commerce via SMS advertisement messages.

28. A method for communicating SMS advertisement messages to a plurality of students at a plurality of universities, each student having a mobile device adapted to receive SMS messages, the method comprising:
providing a messaging platform coupled to the students and a plurality of merchants, the messaging platform adapted to allow the merchants to send SMS advertisement messages to the students at any of the universities;
providing a first user interface that allows each student to select options regarding the SMS messages that the student would like to receive; and
providing a second user interface that allows each merchant to select options regarding the students to whom the advertiser would like to send SMS advertisement messages.

29. A method for providing SMS message services, the method comprising:
providing a plurality of universities with access to a system that is adapted to allow university users to send SMS notification messages to a plurality of their associated students, each student having a mobile device adapted to receive SMS messages;
providing a plurality of merchants with access to the system, which is further adapted to allow the merchants to send SMS advertisement messages to the students who elect to receive such SMS advertisement messages on an opt-in basis; and
charging each merchant a fee for each SMS advertisement message sent via the system.

30. A method for providing SMS message services for university communities comprising university users, a plurality of students and merchants, each student having a mobile device adapted to receive SMS messages, the method comprising:
providing a means for allowing the university users to create SMS notification messages, and to select a category of students to receive each notification messages;
providing a means for allowing each student to select options regarding the SMS messages that the student would like to receive;
requiring that each student agree to receive a minimum number of SMS advertisement messages in a given time period;
providing a means for allowing the merchants to create SMS advertisement messages, and to select a category of students to receive each SMS advertisement message; and
charging each merchant a fee for SMS advertisement messages sent to the students.
